(19) United States
(12) Patent Application Publication
(10) Pub. No.: US 2025/0045514 A1
(43) Pub. Date: Feb. 6, 2025

(54) CONTENT-BASED VALIDATION

(71) Applicant: Walkme LTD., Tel Aviv (IL)

(72) Inventors: Ron Zohar, Givatayim (IL); Moran Shemer, Ra'anana (IL); Netanel Richman, Maskiot (IL)

(21) Appl. No.: 18/788,428

(22) Filed: Jul. 30, 2024

Related U.S. Application Data
(60) Provisional application No. 63/530,184, filed on Aug. 1, 2023.

(51) Int. Cl. G06F 40/174; G06F 3/0481; G06F 9/451; G06F 40/40

(52) U.S. Cl. CPC G06F 40/174; G06F 3/0481; G06F 9/451; G06F 40/40

(57) ABSTRACT

A method, product and apparatus implemented at an end device of an administrator user, comprising: selecting a field in a page of a third-party application; defining a trigger event for identifying that an end user entered input to the field; defining an automation process to be executed in response to the trigger event, said defining comprises defining a validation rule using free text in natural language, the automation process is configured to generate a prompt to a Generative Artificial Intelligence (AI) engine, the prompt comprising the validation rule and instructions to determine whether the input complies with the validation rule; and defining a configuration for presenting an output from the Generative AI engine over the page.

### CROSS-REFERENCE TO RELATED APPLICATION

This application claims the benefit of Provisional Patent Application No. 63/530,184, entitled “Large Language Model-Based Rules In Digital Adoption Platforms” filed Aug. 1, 2023, which is hereby incorporated by reference in its entirety without giving rise to disavowment.

### TECHNICAL FIELD

The present disclosure relates to input validation in general, and to use of Large Language Modes (LLMs) for content-based input validation, in particular.

### BACKGROUND

A digital adoption platform may be a comprehensive software platform designed to facilitate and streamline the adoption and usage of digital tools, applications, and software systems within organizations. It provides interactive guidance, contextual assistance, and personalized training to users, enabling them to navigate and effectively utilize complex software interfaces and functionalities. By offering real-time, step-by-step guidance and performance analytics, digital adoption platforms empower businesses to enhance user productivity, reduce training costs, and maximize return on investment in their digital initiatives.

Advancements in artificial intelligence and natural language processing have led to the development of sophisticated models capable of understanding, generating, and processing human language at an unprecedented scale. For example, a language model such as a Large Language Model (LLM) or a Small Language Model (SML) constitutes an advanced machine learning model trained on vast amounts of textual data, enabling it to comprehend and generate human-like text in a variety of languages. These models employ deep neural network architectures to learn patterns, semantics, and contextual information from textual inputs, enabling them to perform tasks such as language translation, text summarization, sentiment analysis, and even creative writing.

By leveraging their vast knowledge base and language proficiency, language models such as LLMs have the potential to revolutionize various fields, including content generation, customer support, language understanding, and information retrieval, among others. Their versatile capabilities make LLM an invaluable tool for businesses and researchers seeking to harness the power of natural language processing in their applications. Several notable examples of publicly available LLM products are ChatGPT™, BARD™ and BING™ Chat.

### BRIEF SUMMARY

One exemplary embodiment of the disclosed subject matter is a method to be implemented at an end device of an administrator user, the method comprising: selecting a page element in a page of a third-party application, the page element comprising a field, wherein the third-party application is executable on the end device of the administrator user and on a plurality of end devices of end users; defining a trigger event, wherein the trigger event comprises identifying that an end user entered input to the field; defining an automation process to be executed in response to an occurrence of the trigger event, the automation process is configured to generate a prompt to a Generative Artificial Intelligence (AI) engine to incorporate at least the input and a validation rule, wherein said defining the automation process comprises defining the validation rule using free text in natural language, wherein the prompt is configured to be generated to comprise a predefined structure of a static portion and a dynamic portion, wherein the dynamic portion is configured to be populated with inputs from the end users in response to respective invocations of trigger events, wherein the static portion is configured to comprise the validation rule and instructions to determine whether the input complies with the validation rule, the automation process is configured to send the prompt to the Generative AI engine and obtain an output from the Generative AI engine in response to the prompt; and defining a configuration for presenting a result over the page, wherein the result is determined based on the output from the Generative AI engine, the result indicating at least whether the input complies with the validation rule.

Optionally, the prompt is configured to instruct the Generative AI engine to provide content-based feedback on the input, the content-based feedback comprising a suggestion of how to adjust the input in a manner that will comply with the validation rule.

Optionally, the configuration of presenting the result comprises at least one of: updating one or more properties of the page based on the result, the one or more properties comprise at least one of: a border color of the field, a background color of the field, or a highlight of the field; and presenting the result as an overlay over the page, the overlay is configured to be displayed over the page, wherein the overlay is not part of the third-party application, the overlay comprising at least one of: a chat widget, a tooltip, a popup element, or a text field.

Optionally, the dynamic portion is configured to be populated, every invocation of the trigger event, with contextual data, the contextual data comprising data from the page.

Optionally, the data from the page comprises names of other fields in the page and at least some inputs to the other fields.

Optionally, the data from the page comprises validation rules of other fields in the page.

Optionally, the other fields comprise fields of a form, wherein the validation rules of the other fields are defined to validate inputs of the end users into the fields of the form.

Optionally, said selecting the page element, defining the trigger event, defining the automation process, and defining the configuration are performed via a digital adoption platform that is executing on the end device of the administrator user, the digital adoption platform is agnostic to the third-party application, wherein the digital adoption platform is configured to enable administrator users to generate, using the digital adoption platform, an assistance layer to be executed over the third-party application on the plurality of end devices, the assistance layer is configured to assist the end users with performing digital tasks.

Optionally, the instructions of the prompt comprise pre-configured instructions of the digital adoption platform that are not defined by the administrator user.

Optionally, the digital tasks comprise filling out one or more forms in the third-party application.

Optionally, the assistance layer comprises a validation tooltip defined for the field; the validation tooltip is configured to comprise the validation rule.

Optionally, the method further comprises defining to present to the end user a guidance message prior to the input being entered to the field; and selecting the guidance message from a set of one or more pre-defined messages of the validation tooltip, the set of one or more pre-defined messages are historical messages for the field defined by one or more users of an organization to which the administrator user belongs.

Optionally, the configuration of presenting the result comprises presenting the result as a message within a chat widget, the chat widget is overlayed over the page, wherein the input to the field is provided to the chat widget, wherein the automation process is configured to provide a summary of compliant inputs in the chat widget to the field.

Optionally, the Generative AI engine comprises a Large Language Model (LLM) engine or a Small LM (SLM) engine.

Another exemplary embodiment of the disclosed subject matter is an apparatus comprising a processor and coupled memory, said processor being adapted to perform, at an end device of an administrator user, the steps of: selecting a page element in a page of a third-party application, the page element comprising a field, wherein the third-party application is executable on the end device of the administrator user and on a plurality of end devices of end users; defining a trigger event, wherein the trigger event comprises identifying that an end user entered input to the field; defining an automation process to be executed in response to an occurrence of the trigger event, the automation process is configured to generate a prompt to a Generative AI engine to incorporate at least the input and a validation rule, wherein said defining the automation process comprises defining the validation rule using free text in natural language, wherein the prompt is configured to be generated to comprise a predefined structure of a static portion and a dynamic portion, wherein the dynamic portion is configured to be populated with inputs from the end users in response to respective invocations of trigger events, wherein the static portion is configured to comprise the validation rule and instructions to determine whether the input complies with the validation rule, the automation process is configured to send the prompt to the Generative AI engine and obtain an output from the Generative AI engine in response to the prompt; and defining a configuration for presenting a result over the page, wherein the result is determined based on the output from the Generative AI engine, the result indicating at least whether the input complies with the validation rule.

Yet another exemplary embodiment of the disclosed subject matter is a computer program product comprising a non-transitory computer readable medium retaining program instruction, which program instructions when read by a processor, cause the processor to perform, at an end device of an administrator user, a method comprising: selecting a page element in a page of a third-party application, the page element comprising a field, wherein the third-party application is executable on the end device of the administrator user and on a plurality of end devices of end users; defining a trigger event, wherein the trigger event comprises identifying that an end user entered input to the field; defining an automation process to be executed in response to an occurrence of the trigger event, the automation process is configured to generate a prompt to a Generative AI engine to incorporate at least the input and a validation rule, wherein said defining the automation process comprises defining the validation rule using free text in natural language, wherein the prompt is configured to be generated to comprise a predefined structure of a static portion and a dynamic portion, wherein the dynamic portion is configured to be populated with inputs from the end users in response to respective invocations of trigger events, wherein the static portion is configured to comprise the validation rule and instructions to determine whether the input complies with the validation rule, the automation process is configured to send the prompt to the Generative AI engine and obtain an output from the Generative AI engine in response to the prompt; and defining a configuration for presenting a result over the page, wherein the result is determined based on the output from the Generative AI engine, the result indicating at least whether the input complies with the validation rule.

One exemplary embodiment of the disclosed subject matter is a method to be implemented at an end device of an end user, the method comprising: displaying on the end user a third-party application and an assistance layer, the assistance layer is executed over the third-party application; obtaining, from the end user, user input to a field in a page of the third-party application; presenting to the end user a message over the page, the message is obtained from the assistance layer, the message indicating that content of the user input does not comply with a validation rule of the assistance layer, the message provides content-based feedback to the user input, the content-based feedback comprising a suggestion of how to adjust the content of the user input in a manner that will comply with the validation rule, wherein the assistance layer is configured to generate a prompt to a Generative AI engine, send the prompt to the Generative AI engine, and obtain the content-based feedback from the Generative AI engine, the prompt comprising a predefined structure of a static portion and a dynamic portion, wherein the dynamic portion is configured to be populated with the user input every time the field is filled out by the end user, wherein the static portion is configured to comprise the validation rule; and obtaining modified user input to the field, the modified user input is obtained subsequently to said presenting the message.

Optionally, before said obtaining the user input, a guidance message is presented to the end user, the guidance message comprises pre-defined text guiding the end user how to fill out the field, the pre-defined text provided by a builder of the assistance layer.

Optionally, the Generative AI engine comprises an LLM engine or an SLM engine.

Optionally, the dynamic portion is populated with contextual data from the page, the contextual data comprising at least one of: names of other fields in the page, validation rules of the other fields, or inputs from the end user to the other fields.

Optionally, the assistance layer comprises a validation tooltip defined for the field; the validation tooltip comprises the validation rule.

Optionally, the message is presented within a chat widget of the assistance layer, the chat widget is overlayed over the page, wherein the user input to the field is provided via the chat widget.

Another exemplary embodiment of the disclosed subject matter is an apparatus comprising a processor and coupled memory, said processor being adapted to perform, at an end device of an end user, the steps of: displaying on the end user a third-party application and an assistance layer, the assistance layer is executed over the third-party application; obtaining, from the end user, user input to a field in a page of the third-party application; presenting to the end user a message over the page, the message is obtained from the assistance layer, the message indicating that content of the user input does not comply with a validation rule of the assistance layer, the message provides content-based feedback to the user input, the content-based feedback comprising a suggestion of how to adjust the content of the user input in a manner that will comply with the validation rule, wherein the assistance layer is configured to generate a prompt to a Generative AI engine, send the prompt to the Generative AI engine, and obtain the content-based feedback from the Generative AI engine, the prompt comprising a predefined structure of a static portion and a dynamic portion, wherein the dynamic portion is configured to be populated with the user input every time the field is filled out by the end user, wherein the static portion is configured to comprise the validation rule; and obtaining modified user input to the field, the modified user input is obtained subsequently to said presenting the message.

Yet another exemplary embodiment of the disclosed subject matter is a computer program product comprising a non-transitory computer readable medium retaining program instruction, which program instructions when read by a processor, cause the processor to perform, at an end device of an end user, a method comprising: displaying on the end user a third-party application and an assistance layer, the assistance layer is executed over the third-party application; obtaining, from the end user, user input to a field in a page of the third-party application; presenting to the end user a message over the page, the message is obtained from the assistance layer, the message indicating that content of the user input does not comply with a validation rule of the assistance layer, the message provides content-based feedback to the user input, the content-based feedback comprising a suggestion of how to adjust the content of the user input in a manner that will comply with the validation rule, wherein the assistance layer is configured to generate a prompt to a Generative AI engine, send the prompt to the Generative AI engine, and obtain the content-based feedback from the Generative AI engine, the prompt comprising a predefined structure of a static portion and a dynamic portion, wherein the dynamic portion is configured to be populated with the user input every time the field is filled out by the end user, wherein the static portion is configured to comprise the validation rule; and obtaining modified user input to the field, the modified user input is obtained subsequently to said presenting the message.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an exemplary flowchart diagram of a method, in accordance with some exemplary embodiments of the disclosed subject matter;

FIG. 2A shows an exemplary execution of a validation tooltip, in accordance with some exemplary embodiments of the disclosed subject matter;

FIGS. 2B-2C show an exemplary validation tooltip, in accordance with some exemplary embodiments of the disclosed subject matter;

FIGS. 3A-3B show exemplary processes of defining a validation tooltip, in accordance with some exemplary embodiments of the disclosed subject matter;

FIGS. 4A-4H show exemplary scenarios of user interactions with deployed validation tooltips, in accordance with some exemplary embodiments of the disclosed subject matter;

FIGS. 5A-5C show exemplary scenarios of user interactions with a deployed validation tooltip, in accordance with some exemplary embodiments of the disclosed subject matter; and

FIG. 6 shows an exemplary flowchart diagram of a method, in accordance with some exemplary embodiments of the disclosed subject matter;

FIG. 7 shows an exemplary flowchart diagram of a method, in accordance with some exemplary embodiments of the disclosed subject matter;

FIG. 8 shows an exemplary flowchart diagram of a method, in accordance with some exemplary embodiments of the disclosed subject matter;

FIG. 9 shows a schematic illustration of an exemplary architecture in which the disclosed subject matter may be utilized, in accordance with some exemplary embodiments of the disclosed subject matter; and

FIG. 10 shows a schematic illustration of an exemplary environment in which the disclosed subject matter may be utilized, in accordance with some exemplary embodiments of the disclosed subject matter.

### DETAILED DESCRIPTION

One technical problem dealt with by the disclosed subject matter is to aid human users in performing digital tasks. In some exemplary embodiments, digital tasks may comprise actions or activities that users perform using digital devices or platforms. Digital tasks may vary in complexity and purpose, encompassing a broad spectrum of actions conducted in the digital realm. In some cases, performing digital tasks may encompass several operations, such as navigating a website, clicking on links, accessing different pages, selecting page elements, entering data to a data field, selecting an option from a dropdown element, or the like. In some exemplary embodiments, digital tasks may be performed via a digital platform, such as a software application, a desktop application, a web-based application, an operating system, a Software as a Service (SaaS) application, or the like. It may be desired to assist end users with performing digital tasks efficiently, properly, successfully, in a timely manner, or the like.

In some exemplary embodiments, assisting users with digital tasks may be performed using one or more platforms such as a Digital Adoption Platform (DAP). For example, WalkMe™ may constitute a DAP. In some exemplary embodiments, a DAP may be designed to help end users navigate and interact with digital assets. In some exemplary embodiments, a DAP may comprise an editor that enables its users to generate an assistance layer that can be executed over a third-party system (also referred to as “target system”), and assist end users of the third-party system with performing digital tasks. For example, the third-party system may be separate from the DAP, may not collaborate therewith, may not perform Application Programming Interface (API) calls to one another, or the like, and may comprise any software products, applications, or websites.

In some exemplary embodiments, a DAP editor may be used by users such as administrator (admin) users of an organization that has access to the DAP. For example, clients of the DAP may comprise firms (e.g., a bank) that are registered or have access to the service of the DAP editor. In some exemplary embodiments, a DAP editor may comprise a software platform designed to facilitate and streamline the adoption and usage of digital tools, applications, and software systems within the organization. For example, admin users may define a walkthrough for a third-party application through the DAP editor, and the walkthrough may be distributed to end users of the third-party application. In some exemplary embodiments, in addition to generating an assistance layer, a DAP may enable admin users to perform one or more statistical analyses, identify patterns of end user interactions with a digital asset, or the like. For example, based on statistical analyses of user performance when using a DAP-based walkthrough, admin users may extract insights useful for revising the walkthrough, enhancing portions thereof, or the like.

In some exemplary embodiments, admin users may be enabled to design the assistance layer using DAP building blocks, which may be no-code preconfigured building blocks. For example, DAP building blocks may comprise interactive GUI elements or widgets such as launcher widgets, buttons, tooltips, chat windows, balloon layouts, or any other Graphical User Interface (GUI) elements or controls with preconfigured properties. In some exemplary embodiments, the assistance layer may be generated using a no-code platform such as a DAP editor, without requiring the admin user to provide or amend coding. In many cases, digital adoption platforms may be no-code platforms, enabling non-programmers to define, using a simple user interface, automations, rules, or the like, in association with a selected target system, elements thereof, or the like. For example, via a DAP editor, an admin may design interactive guidance, interactive walkthroughs, contextual assistance, personalized training, contextual prompts, or the like, to end users, enabling them to navigate and effectively utilize complex software interfaces and functionalities. In other cases, the assistance layer may be designed via a non-DAP platform.

In some cases, the assistance layer may be designed to be user by end users such as employees of an organization, customers of the organization, users browsing the web, or any other population segment. In some cases, the assistance layer may comprise interactive GUI elements configured to present data to users, to enables users to activate an automation process, or the like. As an example, using the DAP editor, admin users may design the assistance layer to comprise a desired widget (e.g., a walkthrough element), define a behavior (e.g., an automation process) of each widget, define a sequence of one or more trigger events (with or without branch conditions) configured to invoke the behavior, or the like.

In some exemplary embodiments, automation processes may be designed by the admin user, e.g., via the DAP editor, to help end-users to complete tasks, learn new features, overcome obstacles, or the like. For example, a launcher widget (also referred to as “launcher”) may be designed by the admin user to trigger predefined content presentations, such as in response to a user interaction, to a defined event, or the like. As another example, an admin user may design, via the DAP editor, custom tooltips (or “ShoutOuts”) that are configured to draw end-user's attention to a featured text or element, in order to assist end users with understanding the element's functionality or significance. As another example, an admin user may design, via the DAP editor, one or more tooltips (or “SmartTips”) configured to appear when an end user hovers their cursor over a specified element such as a button, icon, or link, and to provide supplementary information about the purpose or function of the associated element. As another example, an admin user may design, via the DAP interface, a validation tooltip or launcher that is configured to validate the end-user inputs to text fields, e.g., indicating whether or not the input to the field complies with predefined rules. For example, a validation tooltip may be configured to validate the end-user inputs automatically, when selected by an end user, or the like.

In some exemplary embodiments, additional aspects of digital adoption platforms are described, inter alia, in U.S. Pat. No. 9,922,008, entitled “Calling-Scripts Based Tutorials”, dated Mar. 20, 2018, U.S. Pat. No. 9,934,782, entitled “Automatic Performance Of User Interaction Operations On A Computing Device”, dated Apr. 3, 2018, U.S. Pat. No. 10,819,664 “Chat-Based Application Interface For Automation”, dated Oct. 27, 2020, U.S. Pat. No. 10,620,975, entitled “GUI Element Acquisition Using A Plurality Of Alternative Representations Of The GUI Element”, dated Apr. 14, 2020, and U.S. Pat. No. 10,713,068, entitled “Acquisition Process Of GUI Elements Using User Input”, dated Jul. 14, 2020, all of which are hereby incorporated by reference in their entirety for all purposes without giving rise to disavowment.

In some exemplary embodiments, DAPs may have one or more drawbacks. For example, their capability of aiding users with performing digital tasks may be limited. For example, DAPs may lack adequate text analysis capabilities, text generation capabilities, or the like, to provide content-based support and guidance. It may be desired to overcome such drawbacks.

Another technical problem dealt with by the disclosed subject matter is the need to adapt platforms such as DAP platforms to offer a wider range of assistance operations to end users. For example, it may be desired to expand the DAP building blocks of the DAP editor to provide more sophisticated DAP building blocks, automation processes, trigger events, or the like.

Yet another technical problem dealt with by the disclosed subject matter is to enhance the performance of field validations, to determine compliance of user input with content-based validation requirements. In some exemplary embodiments, DAPs may provide, as DAP building blocks, validation tooltips for validating fields using one or more regular expressions or syntactical constraints. In some exemplary embodiments, such validation tooltips may be restricted to performing simple validations such as determining whether a field is mandatory, whether the input to the field meets a required string length, whether the input is in a correct language (as selected by the admin user), whether a numeric input is within a specified range, whether the input matches a defined format, whether a password meets complexity requirements, or similar rule-based criteria. It may be desired to overcome such drawbacks, and enable admin users to define validation tooltips with sophisticated content-based validation requirements, that compliance thereto can be estimated in real time.

For example, in some scenarios, digital tasks may encompass a submission of data, text, or the like, such as via digital forms, web-based forms, or the like, into designated third-party systems, websites, applications, or the like. In some exemplary embodiments, designated systems may comprise electronic interfaces designed to collect and organize specific information from end users, such as interactive GUIs of pages presented within software applications or websites, containing designated fields and elements to capture, process, and store user-provided data in a structured manner. In some exemplary embodiments, the interactive GUIs may be designed to enable users to input data, make selections, and perform various actions directly on a screen.

For example, users may be tasked with filling out form fields that are presented by pages of third-party systems, according to requirements of the third-party systems, restrictions of the third-party systems, semantic based restrictions, or the like. In some cases, instead of merely restricting an input of a user to a number of characters, or a similar formal requirement, it may be desired to restrict the input to the field with semantic requirements, e.g., requiring the input to be valuable, to answer a specific question, to provide certain details, or the like. It may be desired to expand the capabilities of validation tooltips to enable them to estimate in real time, during execution of the assistance layer over end devices of end users, whether content-based requirements of a field are complied with. For example, instead of classifying whether a user's numeric input to a field is valid or not valid in a binary manner based on whether the input is within a specified range of values, it may be desired to determine whether the content of the input matches content-based requirements, e.g., whether the input is valuable, useful, consistent with other data records, or the like.

In some cases, there may be a significant challenge of determining compliance of user input with content-based requirements. It may be challenging to assess whether the content of the fields is useful, valuable, consistent with other information available, consistent with a policy, or the like, at least since such determination requires a high level of text analysis capabilities. It may be desired to overcome these challenges.

Yet another technical problem dealt with by the disclosed subject matter is to enhance the performance of field validations, to determine suggestions for modifying user input to adhere to content-based validation requirements. It may be desired to expand the capabilities of validation tooltips to enable them to provide meaningful feedback to inputs that end users provide to text fields, meaningful suggestions for revising their input, or the like. In some cases, generating text with meaningful suggestions of revisions, meaning feedback, or the like, may pose a significant challenge, at least since such tasks require a high level of text analysis capabilities and text generation capabilities. It may be desired to overcome these challenges.

Yet another technical problem dealt with by the disclosed subject matter is to enable clients of a DAP platform to customize the functionality of their field validators. In some cases, different clients of the DAP may design assistance layers over third-party applications, in which same text fields may be used in different manners. For example, two different companies may use a same software application such as SalesForce™, and design assistance layers with validation tooltips to be executed over SalesForce™ and assist their end users with performing digital tasks over SalesForce™. According to this example, the two companies may have different requirements for the same field, and may desire to generate validation tooltips for the same field of SalesForce™ that differ in their requirements and guidance. In some cases, third-party applications may enable their customers to customize their forms in order to address their customers' specific needs, posing additional complexity and challenges. For example, forms of a same third-party application (e.g., SalesForce™) may significantly vary between different customers. It may be desired to overcome such challenges, and enable clients to customize the functionality of their field validators according to their needs, goals, or the like.

It is noted that the term “form”, when used herein, may refer to any page of a third-party application that is rendered and comprises at least one interactable GUI element, such as a text field, a dropdown element, or the like.

One technical solution provided by the disclosed subject matter may be to adapt platforms such as DAPs to provide content-aware DAP building blocks for input validation. In some exemplary embodiments, Artificial Intelligence (AI) language models, such as Large Language Models (LLMs), Small Language Models (SLMs), Generative AI, or the like, may be combined with DAP building blocks such as validation tooltips, to provide customized content-aware validation. For example, LLM engines may be combined with validation rules and/or logic of validation tooltips.

In some exemplary embodiments, DAP building blocks may comprise widgets or GUI elements that may be utilized by an administrator user (also referred to as ‘builder’ or ‘admin user’) for designing an assistance layer that is configured to assist end users with digital tasks over a software application. For example, widgets of an assistance layer may be presented as an overlay over a third-party application. In some exemplary embodiments, DAP building blocks may comprise layout adaptations that may be performed within a GUI, e.g., instead or in addition to employing widgets. For example, DAP building blocks may be used to adjust properties of a GUI element in the GUI.

In some exemplary embodiments, using DAP building blocks, an administrator user may generate an assistance layer from selected types of building blocks, defined positions for each DAP building block over the pages or layouts of a third-party application, selected automation processes (e.g., validation processes) that are linked to each DAP building block, selected trigger events that invoke or activate each automation process, or the like. For example, the administrator user may design and generate the assistance layer over the SALESFORCE® application, or any other application, a combination of applications, or the like, in order to aid users with utilizing the application efficiently.

In some exemplary embodiments, the disclosed subject matter may be configured to adapt platforms such as DAPs to provide a wider range of building blocks, e.g., to include content-aware building blocks that exploit language models such as LLMs. In some exemplary embodiments, instead of configuring a behavior of DAP building blocks such as validation tooltips only according to heuristics, rules, conditions, branches, or the like, that are not content aware, at least some DAP building blocks may be designed to provide content-aware capabilities. For example, content-aware capabilities may comprise text analysis capabilities, text generation capabilities, or the like.

In some exemplary embodiments, a language model such as an LLM engine may comprise a private LLM, a private tenant in a cloud or other remote server, a public LLM such as public Generative Pre-trained Transformers (GPTs), a public LLM that is retrained on a private dataset such as an internal knowledge base, an on-premise LLM, or the like. In some exemplary embodiments, DAP building blocks may utilize one or more additional technologies, such as Natural Language Processing (NLP) models, different Machine Learning (ML) models, AI models, generative AI models, or the like. In some exemplary embodiments, LLM engines may be enabled to obtain text input, and provide content-aware output based on the input. For example, LLM engines may be enabled to analyze input text, and generate output text according to instructions or indications of the input text.

In some exemplary embodiments, content-aware capabilities may be added to existing DAP building blocks such as tooltips by utilizing and/or cooperating with an AI language model such as an LLM. For example, LLM infrastructure may be exploited by launcher widgets, tooltip widgets, or any other type of other DAP building blocks, for assisting end users with content-based digital tasks, in a content-aware manner. For example, LLM infrastructure may be incorporated within automation processes of the DAP building blocks. In some exemplary embodiments, the capabilities of the LLMs may be exploited for performing content-related tasks such as text analyses, text generation tasks, or the like, thereby enhancing the capabilities of DAP building blocks, increasing the variety and quality of available automation processes that can be incorporated in DAP building blocks, or the like.

In some exemplary embodiments, combining LLM infrastructure with DAP building blocks may enable the DAP building blocks to deliver content-based capabilities. In some exemplary embodiments, validation tooltips may be designed to assist end users with filling out a specified field (also referred to as ‘validated field’ or ‘validation field’) in a page of a third-party application. In some exemplary embodiments, validation tooltips may be designed to correspond or implement one or more LLM-based automation processes for the specified field, thereby exploiting LLM technology for validation processes. For example, using an LLM engine, validation tooltips may be configured with an automation process that utilizes the LLM engine for one or more validation tasks. For example, based on the LLM engine, a validation process of a page element of a third-party application may be adjusted to provide content-based feedback on a user's input to the page element, content-based suggestions of revisions to a user's input to the page element, determinations as to whether the input corresponds to stored data records, or the like. These content-based operations that were previously unfeasible, are made feasible by exploiting the LLM engine.

In some exemplary embodiments, in order to assist end users with filling out forms properly, tooltip widgets may be designed and generated to utilize LLM technology to enhance a process of validating the end user's inputs, according to various use cases. For example, LLM technology may enhance the validation process by providing insights regarding the semantic properties of the submitted text, extracting action items from text, classifying free text into predefined buckets, or the like.

In some exemplary embodiments, the editor of the DAP may be adjusted to provide a validation tooltip with content-aware capabilities. In some exemplary embodiments, validation tooltips may be set, designed, defined, or the like, to incorporate LLM rules therein, to enable admin users to define LLM rules, or the like. For example, the editor may provide a dropdown element from which the admin user may select one or more types of validation rules, e.g., LLM rules, regular expression rules, syntactical constraint rules, or the like, for a validation tooltip. In some exemplary embodiments, LLM rules may comprise validation rules that utilize one or more prompts to language models such as LLMs, e.g., as part of the validation process.

In some exemplary embodiments, an LLM rule may indicate a requirement of the admin user, and may be incorporated within a prompt to enable an LLM engine to determine whether user input to a field complies with the requirement of the admin user (the LLM rule). In some exemplary embodiments, a prompt may be designed to compare a free-text natural language instruction provided by the admin user, the LLM rule, with real time inputs from end users. In some exemplary embodiments, the DAP may obtain the free text from the admin user, and generate a prompt based thereon, by instructing the LLM engine to compare the user input to the LLM rule. In some exemplary embodiments, an LLM session may be invoked by generating the prompt according to the provided input from the admin user, incorporating real-time input to the field from an end user, and communicating the prompt to a locally-deployed LLM, a remote LLM (e.g., on a cloud), or the like.

In some exemplary embodiments, prompts may be designed to perform any other content-based task. For example, an admin user may select to incorporate in the prompt a content-generation instruction to determine whether a field complies with a first requirement of the admin user and generate text according to a second requirement of the admin user. As another example, the admin user may provide, as part of the natural language input, a plurality of instructions for content-based tasks (e.g., to generate a revision suggestion to the end user), and the prompt may be generated to incorporate the requirements. In some exemplary embodiments, prompts to the LLMs may instruct the LLMs to perform a content-based validation based on requirements provided by the admin user, the intended input for the respective fields (e.g., as may be stored in a document or repository), or the like.

In some exemplary embodiments, the prompt may be defined in the DAP to have a predefined structure, e.g., a structure comprising a static portion and a dynamic portion. In some exemplary embodiments, the static portion may comprise a cross-client portion that is defined in the DAP and used for all clients. For example, in the case of a validation tooltip, the cross-client portion may instruct the LLM engine to perform validation on input from an end user based on input from the admin user of each client, to use a certain format, or the like. In some cases, LLM rules may comprise, in addition to a validation-related instructions, one or more non-validation instructions such as a format for the output of the LLM engine, text generation instructions, or the like.

In some exemplary embodiments, the static portion may comprise a client-specific portion, which may be defined by an admin user of each client. For example, the client-specific portion may indicate the specific validation that is intended to be performed by the LLM, which output is desired, a desired text generation task, a format of the output, a user segment of end users to which each requirement applies, user constraints of user segments, or the like. As another example, the client-specific portion may indicate a dataset or content source with which the input from the end user must comply with in order to be validated, from which a validation rule may be retrieved, or the like. For example, a content source may comprise a PDF document with form requirements, a website, a repository, a library, or the like.

In some exemplary embodiments, the dynamic portion of the prompt may comprise a portion that is populated with input from the end users every time the prompt is generated (e.g., for end users that execute the assistance layer that is generated by the admin user). For example, the dynamic portion may comprise source data copied from the GUI of the third-party application, e.g., as presented to an end user via a user device. In some exemplary embodiments, the source data may be defined, via the DAP, to comprise input that the end user entered to the field of the tooltip, alone or in addition to contextual data such as a portion of text in the display of the GUI, all text in a rendered page of the third-party application, or the like. In some exemplary embodiments, the dynamic portion may be configured, by the DAP or the admin user, to comprise contextual information of the context of the field, such as field names of other fields in the same page, values provided by an end user to other fields, validation rules of other fields in the page, or the like. It is noted that when providing contextual information, non-filled fields may be identified as having NIL, NULL, N/A value, or the like.

In other cases, validation tooltips may be provided with any other division into static cross-client portion, static client-specific portions, and dynamic portions. For example, the DAP editor may enable admin users to adjust the static cross-client portion, making the entire static portion client-specific.

In some cases, restricting the ability of the admin user from adjusting the static cross-client portion may increase the security of the disclosed subject matter, and the privacy of the end users. For example, in order to ensure that the privacy of end-users is preserved when executing LLM engines, the services provided by LLMs may be restricted to defined domains. In some exemplary embodiments, instead of exploiting LLM capabilities in an unrestricted manner, LLMs may be utilized under a restricted frameworks that is set by the DAP and cannot be altered by customers of the DAP. For example, the prompts to LLMs may be restricted to predefined prompt structures, predefined text portions, or the like.

In some exemplary embodiments, in order to preserve the users' privacy, and not provide their Personal Identifiable Information (PII) or confidential data to the LLM engine (e.g., for an LLM that is not on premise), the PII data may be removed from the prompt, replaced with non-PII data, or the like. In some exemplary embodiments, before data from end users is provided to a public LLM, an anonymization of the data may be performed. In some exemplary embodiments, by removing PII data, the privacy of end users may be maintained.

In some cases, PII data may be identified and replaced using heuristic-based rules (remove or anonymize data that matches email formats, phone number formats, dollar amounts, or the like), private language models, on-premise language models, or the like. PII data may be identified on end devices of end users, on a trusted server, or the like. In some cases, in case of highly sensitive PII data, the prompt may be cancelled and the LLM validation may be blocked (e.g., implementing instead non-LLM validation). In some cases, the PII data may be removed from the prompt, replaced with non-PII data, or the like. For example, in order to ensure that the text remains comprehensive, sensitive data such as names may be replaced with a general name, with a name tag, or the like.

In some exemplary embodiments, in addition to restricting the access of the LLM engine to end user data, the access of the DAP to such data may be restricted. In some exemplary embodiments, in order to prevent leakage of data from end users to the digital adoption platform, the backend of the digital adoption platform may not have access to the prompt that is generated with the input from the end users. Instead, a client-side agent executed on each end device may create the prompt and send it to the LLM engine, while protecting the privacy and confidentiality of the user data that is included therein.

In some exemplary embodiments, the LLM engine may obtain the prompt, such as via a third-party chat GUI, API calls, system calls, or any other interface. In some exemplary embodiments, the LLM engine may process and/or analyze the provided prompt, and generate an output based thereon. For example, the processing at the LLM side may comprise performing text analysis tasks, text generation tasks, NLP processing, semantic analysis, contextual analysis, or the like. In some exemplary embodiments, the output from the LLM engine may be provided to the assistance layer, e.g., to the validation tooltip, extracted thereby, or the like.

In some exemplary embodiments, the validation tooltip may generate an output based on the obtained output from the LLM engine. In some exemplary embodiments, the output of a validation tooltip may be generated based on one or more LLM sessions, one or more non-LLM operations, a combination thereof, or the like. In some exemplary embodiments, the admin user may configure a manner of generating an output to end users. For example, the admin user may define that the validation tooltip should generate an output to include the output from one or more LLM engines, an indication thereof, a processed version thereof, a combination of the LLM's output with predefined text, or the like. In some cases, the output may incorporate a portion of the response from an LLM session, the entire response from the LLM, or the like.

In some exemplary embodiments, the validation tooltip may present the generated output according to one or more presentation configurations, e.g., as set by the admin user. In some exemplary embodiments, the generated output may be configured to be presented over the page of the third-party application. For example, the output may be presented as a message or cue within an overlay over the GUI, such as within a popup element, a tooltip, a window, a balloon, a textbox, a chat widget, or the like. In other cases, the output may be presented by adjusting the layout of the GUI, e.g., without generating and presenting an overlay on top of the GUI. In some exemplary embodiments, the admin user may be enabled to define presentation configurations for presenting the output. For example, the admin may select a target location for presenting the output.

In some exemplary embodiments, the editor of the DAP may enable the admin user to select any other properties of the validation tooltip, such as when the validation rules should be invoked. In some cases, the admin user may define one or more trigger events that, when identified, are designed to cause an execution of the validation rules of the tooltip. For example, the trigger events may comprise determining that an end user entered data to a specified field, that the end user finished to enter the data, that the end user hovered away from the field after entering data to the field, that the end user selected a different field after entering data to the field, or the like.

In some exemplary embodiments, the DAP may allow the admin user or builder, to define the client-specific portion of the prompt to the LLM engine, to define one or more dynamic portions of the prompt that should be extracted from the end users' GUI, or the like. In some cases, one or more functionalities may not be editable by the admin user, e.g., blocking the ability of clients to adjust the cross-client portion of the prompt.

In some exemplary embodiments, after validation tooltips are defined by an admin user, the defined validation tooltips may be compiled, processed, or the like, and deployed on a plurality of user devices, e.g., as part of an execution of an assistance layer. In some exemplary embodiments, the validation tooltip may be distributed to the end devices, embedded in the pages of the digital task, or made accessible to the end devices in any other way. For example, the validation tooltip may be distributed independently or as part of the assistance layer.

In some exemplary embodiments, statistics regarding the performance of the validation tooltips may be gathered, accumulated, measured, analyzed, or the like, such as by the customer that defined the validation tooltips, by the DAP itself, by a server that distributed the tooltips, or the like. In some exemplary embodiments, the performance of the validation tooltips may be measured by determining their effect on end user's success in digital tasks of filling out fields in forms or other pages, before and after deployed the validation tooltips, before and after adjusting configurations of validation tooltips, or the like.

It is noted that validation tooltips, as referred to herein, may refer to any widget or GUI control that can be used to provide textual or non-textual feedback on textual input from users. For example, validation tooltips may comprise launchers or any other DAP building block. It is further noted that although the disclosed subject matter is exemplified with respect to tooltips that are defined in a field level of granularity, e.g., for a specific page element, validations may be defined in any other level of granularity, e.g., in a page level of granularity. For example, the DAP editor may enable the admin user to define a validation rule that applies to an entire page, such as that at least four fields of a form must be filled out by the end users. Page-level validations may be defined via a page-level tooltip, via a general DAP rule, or the like.

One technical effect of utilizing the disclosed subject matter is aiding human users in filling out fields of a form or any other page. For example, using the disclosed subject matter, end users may be assisted with filling out forms efficiently, properly, successfully, in a timely manner, or the like, which may enhance the productivity and engagement of end users.

Another technical effect of utilizing the disclosed subject matter is providing an improvement in DAP platforms, by increasing the capabilities of DAP platforms to offer LLM-based validation processes that can be implemented for DAP building blocks such as tooltip widgets. The disclosed subject matter further enables builders to create tooltips with customized functionalities that match the enterprise's policy and way of working, thus providing customer-specific functionalities using a no-code platform such as a DAP, without requiring the admin user to provide or amend code directly. It is noted that the disclosed subject matter is not limited to a specific digital adoption platform, and can be implemented for non-DAP platforms as well.

Yet another technical effect of utilizing the disclosed subject matter is assisting users with performing content-related digital tasks. For example, the disclosed subject matter enables validation tooltips to automatically generate suggested revisions to input from end users, to determine compliance of their input with certain policies, or the like, based on submitted text to a form.

Yet another technical effect of utilizing the disclosed subject matter is providing a user-friendly solution that may increase a user engagement. In some cases, a human to machine interaction may be enhanced by providing content-based feedback to end users when filling out a form, thereby enabling the user to easily determine the form requirements, a manner of adjusting their input to comply with the form requirements, or the like. In some cases, in order to further enhance the human to machine interaction, a Chabot may be used to communicate with the user in natural language until the required data for the form is obtained.

In some exemplary embodiments, this validation process may be set and achieved simply by updating and configuring a string in the DAP editor, without any programming performed by the administrator user and without requiring any recompilation, distribution, update, or the like, of the underlying system. In some exemplary embodiments, the resulting validation tooltip may enable to validate user inputs that require semantic processing and NLP processing, without being limited to syntactical constraints.

Yet another technical effect of utilizing the disclosed subject matter is paving the way to responsible AI that can be suitable for each enterprise. The disclosed subject matter provides an LLM experience that is predictable, explainable and safe, unlike other forms of generative AI that may not necessarily be responsible. The predictability may be achieved by restricting the adjustable portions of prompts, so that admin users may not be able to modify such portions. In some cases, a same prompt structure may be used for validation tooltips deployed by different customers, in a plurality of scenarios or use cases, for different automation processes, or the like, thereby enabling a wide range of functionalities within a same restricted framework.

Yet another technical effect of utilizing the disclosed subject matter is providing privacy preserving validation, which may assist end users with digital tasks without providing their PII data to the LLM and/or the DAP backend.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

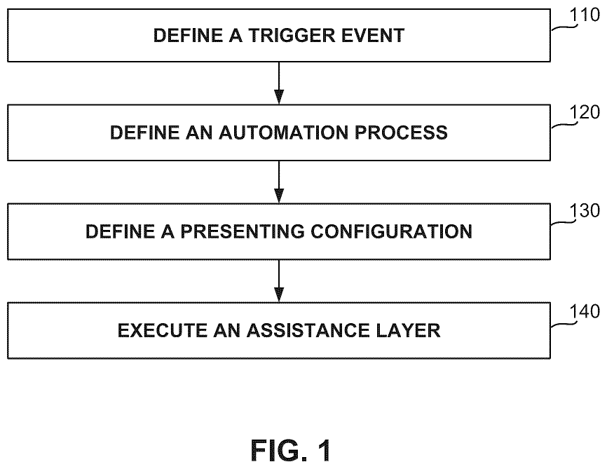

Referring now to FIG. 1 showing an exemplary flowchart diagram of a method, in accordance with some exemplary embodiments of the disclosed subject matter.

On Step 110, an administrator user may define, via a DAP executing on its end device, a trigger event. In some exemplary embodiments, the trigger event may comprise identifying that input is entered to a field by an end user. For example, the admin user may select the field (e.g., as a page element) from a page of a third-party application, and select the trigger event in association with the field. In some exemplary embodiments, the third-party application may be executable on the end device of the administrator user, on a plurality of end devices of end users, or the like.

In some exemplary embodiments, the admin user may define the trigger event to comprise an identification that input is entered to the field by an end user. For example, the identification may comprise identifying that the end user entered input to the field, and that a defined time threshold elapsed since the user stopped entering input to the field (indicating that the end user finished to enter the input to the field). As another example, the identification may comprise identifying that the end user entered input to the field, and then hovered to a different page element or away from the field. As another example, the identification may comprise identifying that the end user entered input to the field, and then selected another page element. In other cases, any other indication may be used to determine that the end user provided input to the field, finished to provide the input, or the like.

In some cases, the admin user may define to present to the end user one or more guidance messages prior to the trigger event, e.g., upon determining that the field is visible to the user, that the user selected the field, that the user started to insert data to the field, or the like. For example, a guidance message may guide the user how to fill out the field before the validation of the user's input is performed. In some cases, a guidance message may be defined by the admin user, or may be selected from a set of one or more pre-defined messages of the validation tooltip. For example, the set of one or more pre-defined messages may be historical messages defined by one or more users of an organization to which the administrator user belongs, defined by the DAP, or the like.

On Step 120, an automation process may be defined to be executed in response to an occurrence of the trigger event. In some exemplary embodiments, the automation process may be configured to execute a prompt to one or more LLM engines, and to obtain an output from the LLM engine in response to the prompt.

In some exemplary embodiments, the automation process may be configured to generate the prompt to incorporate at least the input and one or more validation rules configured to validate the input, generate guidance and assistance to adjust the input, or the like. For example, while defining the automation process, the admin user may define a validation rule using free text in natural language, e.g., according to desired validation policies, form requirements, or the like.

In some exemplary embodiments, the prompt may be structured to instruct an LLM engine to determine whether the input complies with the validation rule, to provide feedback on the input, to suggest how to adjust the input in a manner that will comply with the validation rule, or the like. For example, the prompt may ask the LLM whether the input from the end user complies with one or more validation rules defined by the admin user.

In some exemplary embodiments, the automation process may be configured to generate the prompt in one or more defined manner. In some exemplary embodiments, the automation process may be configured to generate the prompt to comprise a predefined structure of a static portion and a dynamic portion. In some exemplary embodiments, the dynamic portion may be configured to be populated, every invocation of the trigger event, with inputs from end users, with contextual data from the page of the field, or the like. For example, contextual data may comprise names of other fields in the page, one or more inputs to the other fields, validation rules of other fields in the page, or the like. In some cases, the other page fields comprise fields of a form, and the validation rules of the page fields may be defined (e.g., by the admin user or another entity) to validate inputs of end users into the page fields.

In some exemplary embodiments, the static portion may be configured to comprise text that remains unaltered throughout trigger events of different end devices. As an example, the static portion may be configured to comprise the validation rule that is configured to validate the input (e.g., as defined with free text by the admin user). In some exemplary embodiments, the static portion may be configured to comprise one or more cross-client portions and one or more client-specific portions. For example, each client may enable to define its own client-specific validation rule, while one or more portions of the prompt may be cross-client and may not be adjustable by admin users.

In some exemplary embodiments, the automation process may be configured to provide the generated prompt to the LLM engine and obtain an output from the LLM engine in response to the prompt. In some exemplary embodiments, the automation process may be configured to generate a result based on the obtained output from the LLM engine. It is noticed that a plurality of LLM engines, non-LLM engines (e.g., performing heuristically defined operations), or the like, may be used by the automation process. For example, the automation process may generate a message to incorporate at least a portion of the output from the LLM engine, one or more pre-defined text portions, or the like. In other cases, the message may be generated by a different process of the validation tooltip, e.g., not by the automation process.

On Step 130, a configuration for presenting the result over the page may be determined, defined, or the like.

In some exemplary embodiments, the result may be generated to indicate at least whether the input complies with the validation rule, to provide feedback on the input, to provide a suggestion of how to adjust the input in a manner that will comply with the validation rule, or the like. In some exemplary embodiments, the result may be determined based on one or more outputs from one or more LLM engines, non-LLM engines, or the like. For example, the result may be determined based on an output from at least one LLM engine. In some exemplary embodiments, the result may be generated by the automation process, by an engine of the validation tooltip, by an engine of the DAP, or the like.

In some exemplary embodiments, the result may be configured to be presented as a message that is adjacent to the field, as a change to the page layout, as one or more overlays, or the like. For example, the configuration of presenting the result may comprise updating one or more properties, such as color (e.g., of the field's background, border, or the like), highlights, or the like, of the page. As another example, the configuration of presenting the result may comprise presenting the result as an overlay over the page. According to this example, the overlay may a chat widget, a tooltip, a popup element, a text field, a message balloon, or the like, which are not part of the third-party application.

In some exemplary embodiments, the trigger event, automation process, and presentation configuration may be defined by the administrator user, as part of a definition of a validation element such as a tooltip, in a digital adoption platform that is agnostic to the third-party application. In some exemplary embodiments, the digital adoption platform may be configured to enable administrator users to assist end users with digital tasks such as filling out forms. In some exemplary embodiments, the administrator user may be enabled to generate, using the digital adoption platform, an assistance layer to be executed over the third-party application. The assistance layer may be executable over a plurality of end devices, and may be configured to assist end users with filling out fields in the third-party application.

In some exemplary embodiments, the assistance layer may define a validation tooltip for a field, a page with fields, or the like. In some exemplary embodiments, the validation tooltip may be configured to comprise an automation process with one or more validation rules, e.g., the validation rule defined by the admin user.

In some exemplary embodiments, the digital adoption platform may or may not block the admin user from performing certain changes to the validation element, e.g., to the prompt of the automation process. For example, the static portion of the prompt may be configured to comprise pre-configured instructions that are not defined by the administrator user, that cannot be modified thereby, or the like (e.g., stating that the LLM engine should determine whether the input complies with the validation rule). For example, the pre-configured instructions may comprise cross-client instructions that are defined by admin user of the digital adoption platform, not by admin users of any client of the DAP.

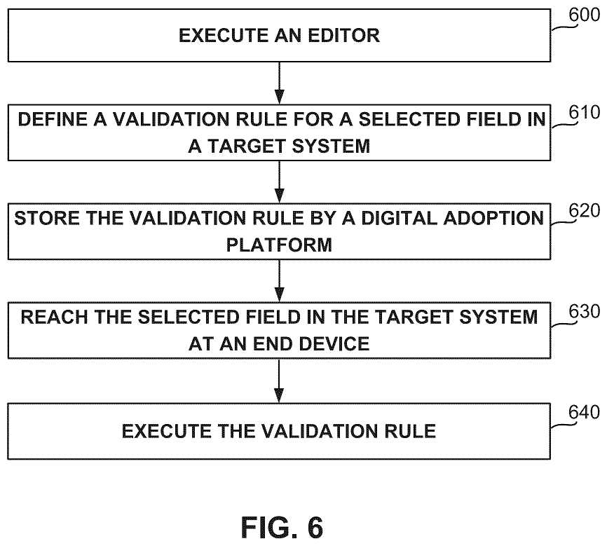

On Step 140, after the assistance layer is generated to comprise at least the validation tooltip, the assistance layer may be executed over end devices of end users, thereby assisting the end users with filling out forms. For example, the assistance layer may be generated and executed according to the method of FIG. 6.

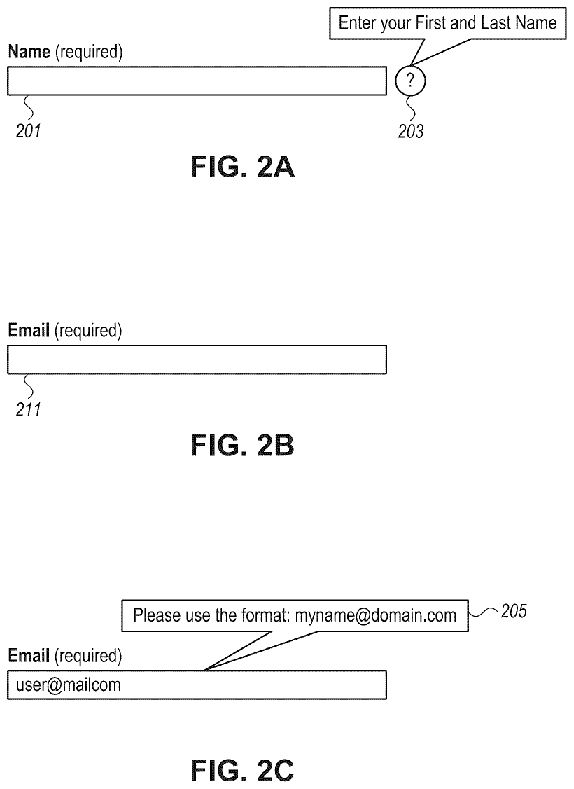

Referring now to FIG. 2A showing an exemplary execution of a validation tooltip, in accordance with some exemplary embodiments of the disclosed subject matter.

In some exemplary embodiments, as depicted in FIG. 2A, a GUI of a third-party application may comprise Text Field 201, titled “name”. For example, Text Field 201 may be part of a form of the third-party application, which may be required to be filled out by end users as part of a digital task.

In some exemplary embodiments, an assistance layer defined using the DAP may be executed over the third-party application, on end devices of end users. For example, the assistance layer may be not be defined according to the method of claim 1, and may not generate a prompt to the LLM engine. In some exemplary embodiments, the assistance layer may execute a validation tooltip of Text Field 201 that is defined to validate user input to Text Field 201, and to provide, to end users, guidance on how to fill out Text Field 201 properly.

For example, the tooltip may be configured to provide a guidance message before input is provided to Text Field 201, e.g., in response to determining that Text Field 201 is visible to the user, in response to a user interaction with an overlay of the assistance layer such as Element 203, or the like. According to this example, the guidance message may display a message to the end user, guiding the user on how to input the correct information (“Enter your first name and last name”).

Referring now to FIGS. 2B-2C showing an exemplary execution of a validation tooltip, in accordance with some exemplary embodiments of the disclosed subject matter.

In some exemplary embodiments, as depicted in FIG. 2B, a GUI of a third-party application may comprise Text Field 211, titled “Email”. For example, Text Field 211 may be part of a form of the third-party application, may be adjacent to Text Field 201, or the like.

In some exemplary embodiments, an assistance layer defined by the DAP may be executed over the third-party application, and may comprise a validation tooltip of Text Field 211 (e.g., separate from the tooltip of Text Field 201) that is defined to validate user input to Text Field 211, to provide guidance on how to fill out Text Field 211, or the like. In contrast to the tooltip of Text Field 201, the tooltip of Text Field 211 may not be configured to provide a guidance message before input is provided to Text Field 211.

In some exemplary embodiments, after input is provided to Text Field 211 (e.g., a trigger event), the tooltip of Text Field 211 may be configured to execute an automation process configured to validate the input. For example, the validation tooltip of Text Field 211 may not utilize a prompt to the LLM engine, and thus may be configured to evaluate whether the user input matches one or more regular expressions or syntactical constraints. For example, once the end user enters a value to Text Field 211, the validation tooltip of Text Field 211 may determine whether the input matches a predefined format, using one or more heuristic rules (string comparisons). In some exemplary embodiments, in case the condition fails, and the user input does not match the defined rule, the validation tooltip may display a preconfigured message to the end user, such as Message 205 of FIG. 2C, indicating that the user's input was incorrect. For example, Message 205 may explain the user how to use the right format (“Please use the format: myname@domain.com”).

In some exemplary embodiments, tooltips with automation processes that are defined using merely regular expressions or syntactical constraints, may have one or more drawbacks, as they may not perform any content-based analysis of the input, may not be able to generate suggestions to users that were not scripted directly by an admin user, or the like. It is noted that scripted messages may relate to messages with pre-written text is that set in advance and fixed.

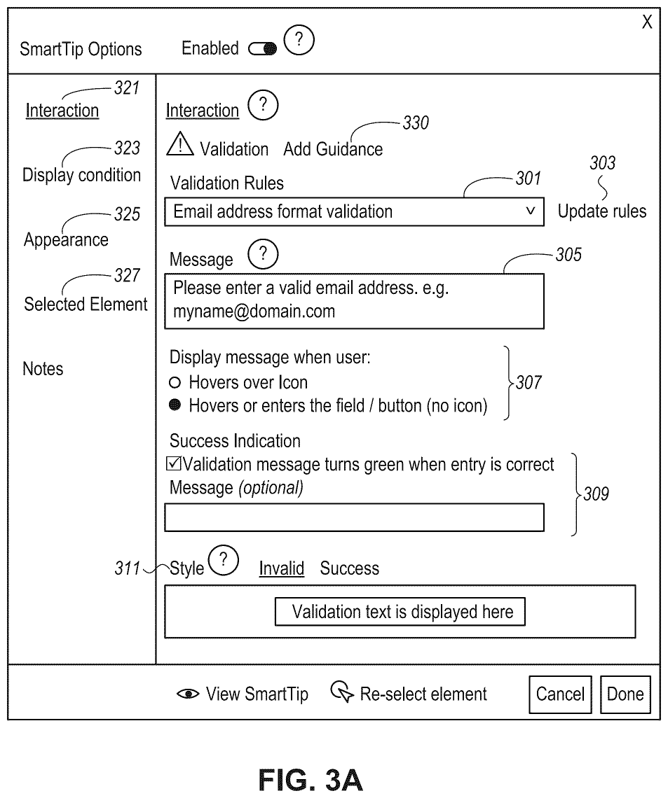

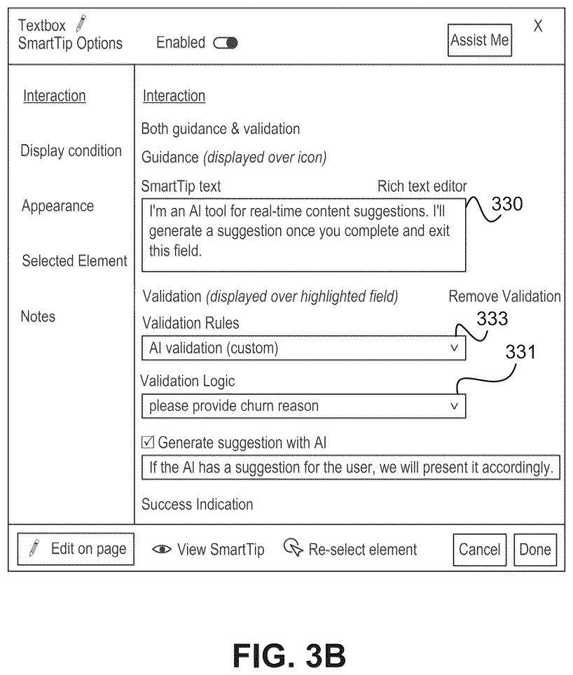

In some exemplary embodiments, an editor of the DAP, such as a drag and drop editor, may be adjusted to allow admin users (of DAP clients) to define automation processes that can perform content-based tasks. For example, FIG. 3B depicts a GUI of an editor that may be used to define enhanced content-based validation tooltips, which may be enhanced with respect to the validation tooltips of FIGS. 2A-2C.

Referring now to FIGS. 3A-3B showing exemplary processes of defining a validation tooltip, in accordance with some exemplary embodiments of the disclosed subject matter.

In some exemplary embodiments, an administrator user associated with a client may define, configure, set, or the like, a validation tooltip via an editor of the DAP. In some exemplary embodiments, the admin user may not be required to be a programmer or have any technical understandings in order to define the validation tooltip, at least since the editor may comprise a no-code platform with a GUI that can be easily operated by novice users.

In some exemplary embodiments, via the editor, the admin user may define one or more properties of a validation tooltip. For example, the admin user may define Interaction Conditions 321, setting the interaction configurations of the validation tooltip with the end users and the automation process of the validation tooltip. As another example, the admin user may define Display Conditions 323, setting when messages or other output of the tooltip should be presented. As another example, the admin user may define Appearance Conditions 325, setting appearance properties of the tooltip. As another example, the admin user may define Selected Element 327, setting an attached page element with which the tooltip is associated (e.g., an associated text field).

In some exemplary embodiments, via the editor, the admin user may set properties of Interaction Conditions 321, such as stating guidance text of Guidance 330, which may be configured to be presented as a message in association with the page element before any input from end users is obtained.

In some exemplary embodiments, the admin user may define one or more Validation Rules 301 to be executed over user input, in order to determine whether the input is proper, correct, or the like. In some exemplary embodiments, Validation Rules 301 may be defined using a rule engine of the DAP, which may evaluate rules and determine whether they are held or not. In some cases, when setting Validation Rules 301, the administrator user may select rules from a set of pre-defined validation rules that are not content-aware (e.g., email address format validation; phone number format validation; or the like). In some exemplary embodiments, the admin user may be enabled to define a custom rule via the editor using one or more regular expressions, syntactical constraints, or the like. For example, selecting on Update Rules 303 may provide the user with a GUI for defining new custom rules and adjusting existing rules.

In some exemplary embodiments, via the editor, the admin user may define at least one Message 305 or other output to be presented by the tooltip in case that the user input does not comply with the validation rules. For example, Message 305 may correspond to Message 205 of FIG. 2C, and no other message may be presented to the end user regardless of what kind of mistake was performed by the end user.

In some exemplary embodiments, the administrator may set configurations such as a display condition determining when the success and/or failure messages or indications should be presented. For example, the admin user may define via Message Display Conditions 307 when Message 305 should be presented (e.g., when hovering over the text field, when entering an input, or the like), when the success indication should be presented, or the like. As another example, the admin user may define via Success Indication 309 one or more visual or non-textual indications of validated input, a success message configured to be presented in case of a valid input, or the like. As another example, the admin user may define via Presentation Configurations 311 a location of presenting the failure message (Message 305), a location of presenting the success indication and/or message with respect to a page element with which the tooltip is associate, appearance properties of Message 305, appearance properties of success indications (e.g., size, font, color, or the like), or the like.

In some exemplary embodiments, the administrator may set configurations such as validation rules for different user segments. In some cases, the digital adoption platform may identify the active end user and select a validation rule for the end user with respect to the specific form/field that is being used. The selection may be based on a segment to which the end user is associated. The segment may be based on an organizational unit of the end user, a role of the end user, a geographic location of the end user, or the like. In some cases, the digital adoption platform may utilize different validation rules for end users in different segments. It is noted, however, that in some cases, the rules may be homogenous for different segments, e.g., two different end users that are associated with two different segments may still be handled using the same validation rule.

In the scenario of FIG. 3A, the administrator user may define the validation tooltip of FIGS. 2B-2C by selecting “email address format validation” as the validation rule of the tooltip, and defining the message “Please use the format: myname@domain.com” to be shown once the validation rule is violated. In other cases, any other message may be specified. For example, the user may specify the message to say: “Please enter a valid email address. E.g. myname@domain.com”.

In production, once the end user has inputted information into the field, the validation rule may be applied, executed, or the like, to determine whether the validation is successful or not. In some cases, if the validation fails, Message 305 may be presented to the end user to notify the end user of their failure. In some exemplary embodiments, if the validation is successful, a success indication and/or message may be presented.

In some exemplary embodiments, the DAP editor may be enhanced, adjusted, or the like, to include more advanced and sophisticated validation rules. In accordance with the disclosed subject matter, instead of using conditions that are based on a propositional formula that can be evaluated in view of values of different variables, the rule engine may utilize LLM-based rules. For example, instead of merely defining the validation rules using regular expressions and/or syntactical constraints, the DAP editor may incorporate language models such as LLMs, Natural Language Processing (NLP) models, different Machine Learning (ML) models, AI models, generative AI models, or the like, in order to enable administrator users to utilize content-based rules for the automation process.

In some exemplary embodiments, content-based rules, also referred to as “LLM rule” or “fill requirement” may be validation rules that can be defined, selected, or the like, by the admin user. In some exemplary embodiments, content-based rules may be selected from a set of content-based validation rules or automation processes that utilize LLM engines to perform content-aware tasks. For example, the set of rules may be defined by other entities, by the same admin for a different field, by the DAP, or the like. In some cases, selecting a pre-set automatic process from a set of pre-set automatic processes, may cause other settings of the validation tooltip to be set automatically, such as by automatically setting a respective result presentation configuration.

In some exemplary embodiments, content-based rules may comprise custom rules defined by the admin user. For example, the admin user may select a type of the validation rule to be a content-based rule, such as by selecting “AI validation” from Validation Rules 333 of FIG. 3B. In some exemplary embodiments, the admin may be enabled to provide, via a GUI of the DAP, free text, specifying, in natural language, a validation rule or requirement. As depicted in FIG. 3B, the admin user may Specify, in a field such as Validation Logic 331, an LLM rule using free text. The admin may define the content-based rules using free text that explains when the value is to be held as true and when as false. For example, the admin may write “please provide churn reason” in Validation Logic 331, causing the LLM rule to require user input to provide the churn reason.

In some cases, the admin may be enabled to use natural language to describe complex content-based validation rules for a text field that the end users' input must adhere to. For example, the validation rules may have one or more conditions, branches, user segmentations (e.g., a first content-based rule for a first user segment, a second rule for a second segment, and so on), or the like.

As an example, a content-based rule may be defined as part of an automation process of a field in which end users are expected to specify their churn reason. In this example, the admin user may define the LLM rule with free text such as: “provide accurate information about the churn reason for this opportunity. If this is a technical or product related reason it needs to be clear how it could have been prevented”. In some exemplary embodiments, in other examples, any other text with any other validation rules may be provided by the admin user, in addition or instead of the above text. In some exemplary embodiments, the free text defining the custom rule may comprise any requirement at any complexity level, with any number of condition branches, with any semantical requirements, any level of detail regarding different scenarios, or the like.

In some exemplary embodiments, the free text that is specified by the admin user may be concatenated or incorporated within a predefined structure of a prompt, defined by the DAP. For example, the DAP may be configured to generate a prompt to an LLM engine, asking the LLM engine to process inputs from end users according to the LLM rule that is specified by the admin user.

In some exemplary embodiments, the prompt may be defined to have a predefined structure, e.g., a structure comprising a static portion is cross-client (asking the LLM engine to process inputs from end users according to the LLM rule that is specified by the admin user), a static portion that is client-specific (the LLM rule that is specified by the admin user), and a dynamic portion that is end-user specific (inputs from end users). For example, the client-specific static portion may be specific to the validation task intended to be performed by the LLM as defined by the admin. In some exemplary embodiments, the static portion of a prompt of a validation tooltip generated by an admin user may remain constant or static throughout executions of the tooltip on end devices, while the dynamic portion may change dynamically according to the inputs that end users provide to the field.

In some exemplary embodiments, the prompt may be defined to include the validation rule, roleplaying instructions, target field label, information regarding other fields in the same page, information regarding the page, or the like. For example, the prompt may state: “determine whether the following rule is held “[VALIDATION RULE]” with respect to a form that is being filled that has the following fields and values “[FIELD₁]”=[VALUE₁], “[FIELD₂]”=[VALUE₂], . . . , “[FIELDₙ]”=[VALUEₙ]. Provide the response in JSON format {rule:x} where x is either TRUE or FALSE”. The LLM engine may evaluate the prompt and provide a response, e.g., in a desired format. The response may indicate a semantic evaluation of compliance of the input with the validation rule.

As another example, once the end user inputs the value of the field, a prompt may be generated by concatenating the LLM rule with the input value to the field and with cross-client static text, resulting with prompt such as: “assuming the fill requirement for a field in a form is to [FILL-REQUIREMENT], provide a grade 0-5 to the following response filled by a user, where 5 means the response is fully compliant with the above requirement and 0 means it is totally irrelevant or not valuable with respect to the above requirement. The user's response is [FIELD-VALUE]. Provide the grade in JSON format {grade:x} and do not include any explanations except for the JSON output”. According to this example, [FILL-REQUIREMENT] may be replaced for each client with their defined LLM rule, as defined by the admin user(s), and [FIELD-VALUE] may be dynamically populated with text input from end users of the client. In some cases, a prompt may be configured to instruct the LLM to provide a result in a specific manner, format, or the like, e.g., in JSON format or any other format. In other cases, the prompt may be defined in any other way, to express the desired requirements of the client in any other manner.

In some exemplary embodiments, the prompt may be generated to incorporate contextual data from end devices of end users, e.g., in order to enable the LLM engine to perform contextual analyses. In some cases, in order to enable a contextual analysis (e.g., as part of the validation of the input or separately therefrom), the admin user may configure the prompt to include contextual data in the dynamic portion of the prompt. For example, instead of the dynamic portion of the prompt including only the input from end users, the dynamic portion may be defined to include contextual information regarding the GUI with which each end users interact, such as information regarding additional fields in the same GUI of the third-party application, the names of all the fields of the page with which the end users interact, the values provided to other fields in the page besides the field of the tooltip, validation rules of other fields, or the like. In some cases, the admin user may define or select (from preconfigured options in the DAP) to add contextual data to the prompt, which contextual data to add, or the like. For example, providing the contextual data in the prompt may allow the LLM engine to take into account the context of the user input, thereby increasing the accuracy of the answer.

In some exemplary embodiments, in case the prompt is configured to incorporate contextual data, the LLM rule may or may not relate to the contextual data. For example, the LLM rule may be defined by the admin user to request output that is consistent with values of other page fields. As another example, the LLM rule may request from the LLM to determine whether the user input adds value over the information in other page fields. As another example, the validation of the user input may be required to be consistent with another field in the page with which the end user is interacting. As another example, the LLM rule may not relate to the contextual data, causing the contextual data to be used by the LLM engine for increased accuracy.

For example, an LLM rule that does not relate to contextual data may result with a prompt such as, for example: “assuming the fill requirement for a field in a form is to “[FILL-REQUIREMENT]”, and the values of the other fields of the form are [FIELD1-NAME]=“[FIELD1-VALUE]”, [FIELD2-NAME]=“[FIELD2-VALUE]”, . . . [FIELDn-NAME]=“[FIELDn-VALUE]” provide a grade 0-5 to the following response filled by a user, where 5 means the response is fully compliant with the above requirement and 0 means it is totally irrelevant or not valuable with respect to the above requirement. The user's response is “[FIELD-VALUE]”. Provide the grade in JSON format {grade: x} and do not include any explanations except for the JSON output”.

As another example, an LLM rule may relate to contextual data directly, such as in case that the LLM rule requires the user input to be consistent with another page field. This may result with a prompt such as, for example: “assuming the fill requirement for a field in a form is to “the value in must be a KPI that is fully relevant to the goal that is defined in field named [OTHER-FIELD]”, and the values of the other fields of the form are [FIELD1-NAME]=“[FIELD1-VALUE]”, [FIELD2-NAME]=“[FIELD2-VALUE]”, . . . [FIELDn-NAME]=“[FEILDn-VALUE]” provide a grade 0-5 to the following response filled by a user, where 5 means the response is fully compliant with the above requirement and 0 means it is totally irrelevant or not valuable with respect to the above requirement. The user's response is “[FIELD-VALUE]”. Provide the grade in JSON format {grade: x} and do not include any explanations except for the JSON output”.

In some exemplary embodiments, after defining the validation rule of the prompt, its dynamic portion, or the like, the prompt may be provided to one or more LLM engines during execution. In some exemplary embodiments, an LLM engine may be configured to process obtained prompts according to the LLM rule that was defined by the admin. For example, according to the above example, the LLM engine may be configured to provide a grade that is based on whether the value that the end user has inputted is compliant with the LLM rule, in view of contextual data. As another example, in case the contextual data comprises validation rules of other fields, the LLM engine may estimate the intended functionality of each page element based thereon, and use this understanding to increase the accuracy of its output.

In some exemplary embodiments, in additional to instructing the LLM to validate the end users' inputs, the LLM rules may instruct the LLM engine to perform text generation tasks, e.g., as defined by the admin user. For example, an LLM rule may incorporate text that requests from the LLM engine to provide suggested improvements to the information that is inputted by the end user, to suggest an alternative input to the end user, to suggest revisions or modifications to the input from the end user, to provide content-based feedback on the input, or the like. As another example, the prompt itself, not the LLM rules, may be adjusted to request a text generation task from the LLM engine.

For example, the prompt may be adjusted to recite: “assuming the fill requirement for a field in a form is to “[FILL-REQUIREMENT]” provide a grade 0-5 to the following response filled by a user, where 5 means the response is fully compliant with the above requirement and 0 means it is totally irrelevant or not valuable with respect to the above requirement. The user's response is “[FIELD-VALUE]”. Provide the grade, and if the grade is not 5, describe what is missing in the data to get to 5. Please provide the response in JSON format {grade:x, missing_data:y} and do not include any explanations except for the JSON response”. According to this example, in case the prompt is used for a field relating to a churn reason of end users, the LLM engine may provide one or more responses depending on the input from the end user, such as {“grade”:4, “missing_data”: “It is not clear how this technical issue could have been prevented”}.

In some exemplary embodiments, this validation process, using a prompt with LLM rules, contextual data, text generation requests, or the like, may be set and achieved simply by updating and configuring a string in the DAP editor, without any programming performed by the administrator user and without requiring any recompilation, distribution, update, or the like, of the underlying third-party system. In some exemplary embodiments, the resulting validation tooltip may enable to validate user inputs to a field that require semantic processing and NLP processing, to provide meaningful feedback, or the like, in a content-aware manner without being limited to syntactical requirements.

In some exemplary embodiments, in addition to field-specific LLM rules, one or more LLM rules may be defined in different levels of granularity. In some cases, validation rules may be defined in a field level, in a page level, in a website level, or the like. For example, a tooltip or other widget may be defined in a page level, and its validation rule may comprise a page-level LLM rule. In some exemplary embodiments, page-level validation rules may be defined with respect to all page elements, a subset of page elements, or the like. For example, an administrator user may define a page-level LLM rule for a specific page, form, or the like, to recite: “every answer in the form should include at least 3 lines”, thereby applying the rule to all page elements. As another example, a page-level validation rule may be defined by the administrator user to relate to several fields of a page, such as by defining the LLM rule to recite: “the user must fill at least 3 goal fields, and for each goal identify in its description field how success is measured and a time frame for completing the goal”. According to this example, the page comprises a plurality of goal fields, and a plurality of description fields, and the end user is required to fill at least three goal fields and the associated description fields, thereby applying to a subset of the page elements.

In some exemplary embodiments, page-level validation rules may be applied sequentially after each field is filled out by an end user, or in parallel, after all fields are filled out and/or a respective form is submitted. For example, a page-level LLM rule may be applied to each field that is filled out to ensure that the information inputted by the end user is compliant with the page-level rule. As another example, when an end user selects a control (e.g., a “submit” button) to submit a form, all the inputs of the end user may be validated at this stage before enabling the submit command to propagate. In other cases, validation rules may be applied in any other order, according to their level of granularity or regardless thereof.

In some exemplary embodiments, after a validation tooltip is designed by an admin user, it may be executed over third-party applications that are rendered on end devices of end users. For example, validation tooltips may be executed as part of an assistance layer that is executed over a third-party application and is configured to augment the third-party application with additional functionality, content, markings, or the like.

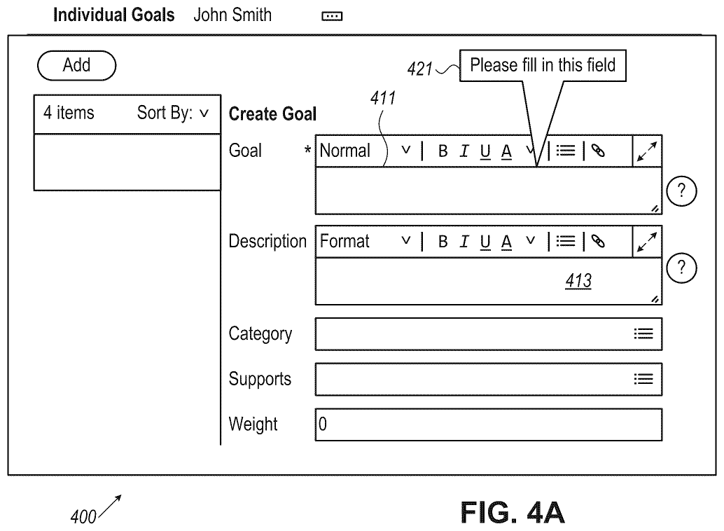

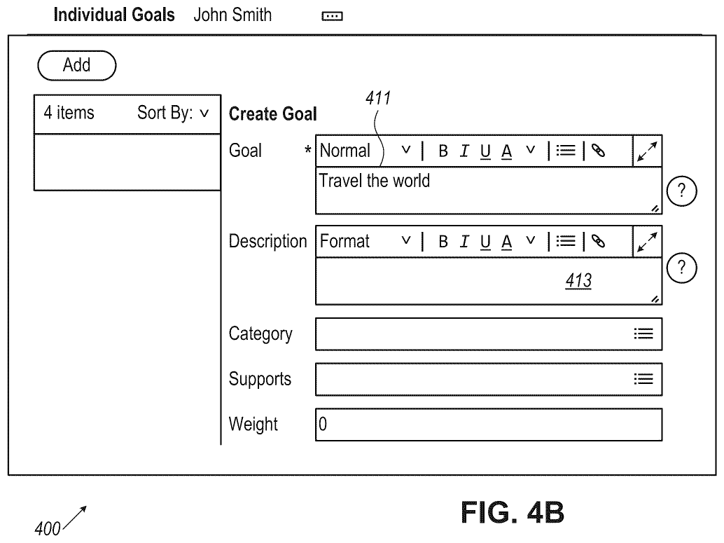

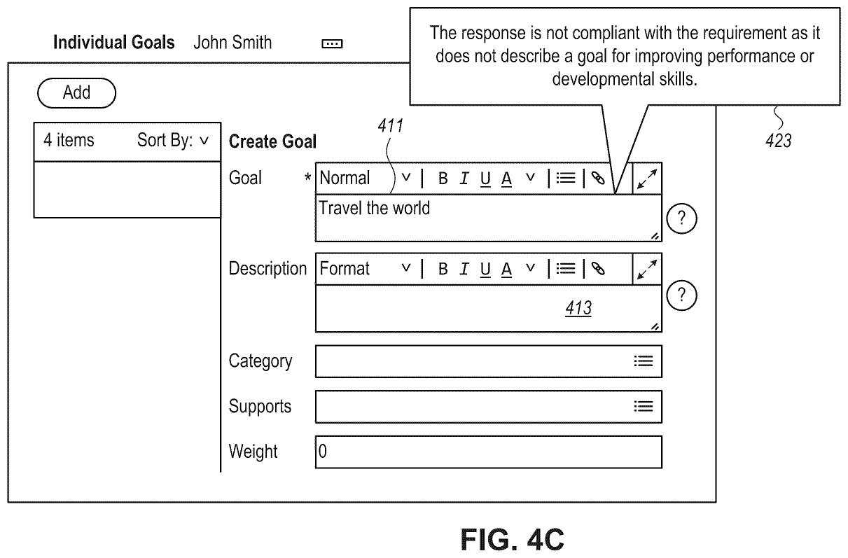

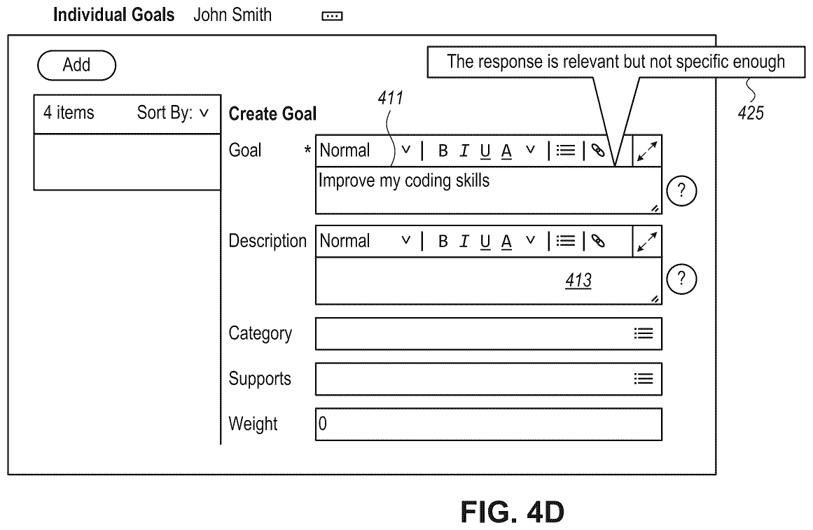

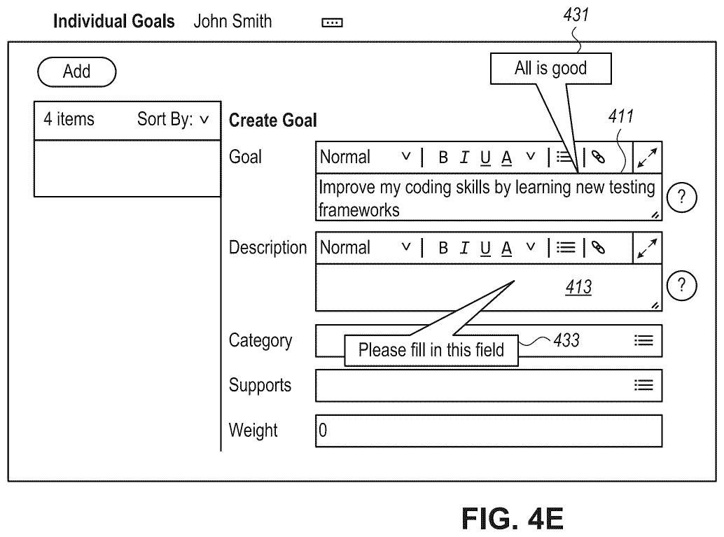

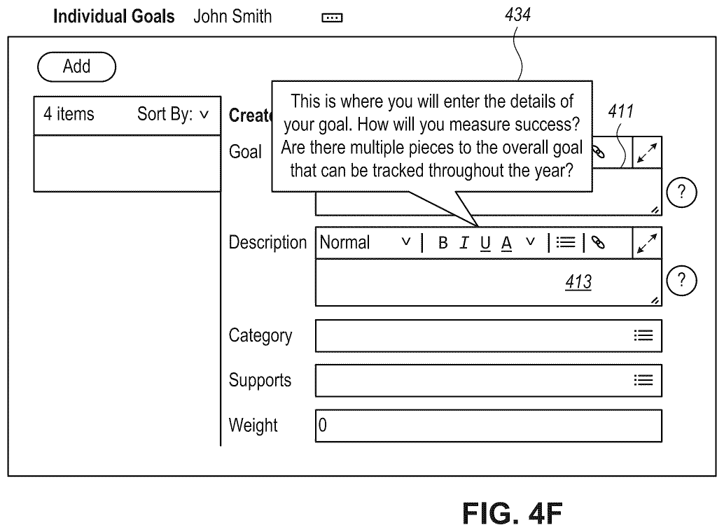

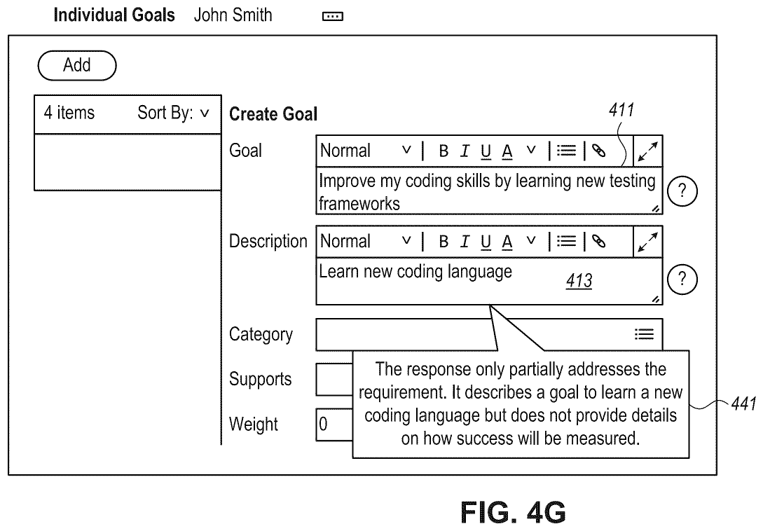

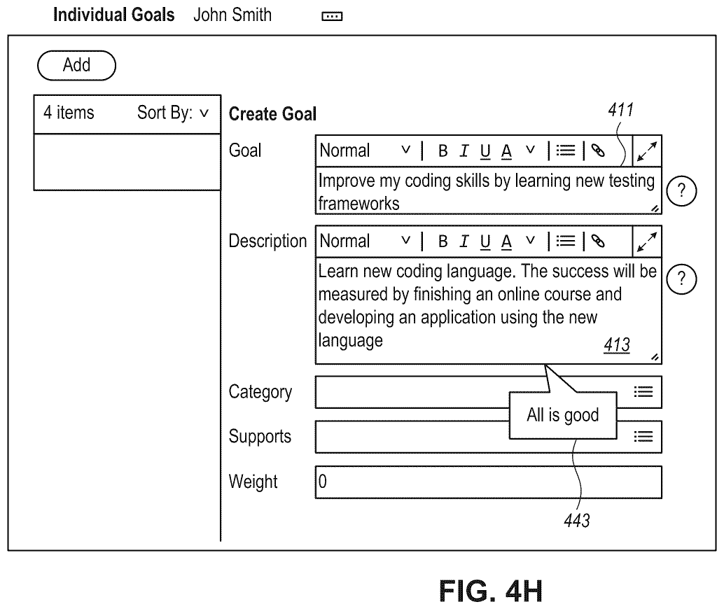

Referring now to FIGS. 4A-4H showing exemplary scenarios of user interactions with deployed validation tooltips, in accordance with some exemplary embodiments of the disclosed subject matter.

In some exemplary embodiments, as depicted in FIG. 4A, a Page 400 of a third-party application is rendered and presented to an end user. In some exemplary embodiments, the third-party application may be executed along with an assistance layer defined by a client (using a DAP). In some exemplary embodiments, the assistance layer may be configured to augment the GUI of Page 400 to provide assistance and content-based validation of user input into the fields of Page 400.

In some cases, the client defining the assistance layer may comprise an organization that has access to a DAP platform, and the third-party application may comprise an application that is not associated with the DAP platform, and potentially also not associated with the client. For example, the client may comprise a bank, and the third-party application may comprise Microsoft Word™, which may be utilized by the bank's employees and/or end users, although the bank may not have access to the backend of Microsoft Word™, to its stored data, to its API, or the like. According to this example, an admin user may define, on behalf of the bank, an assistance layer that is configured to be executed over Microsoft Word™, in order to assist in bank-associated digital tasks that utilize Microsoft Word™. In other cases, the third-party application may comprise the bank's proprietary application, to which the bank may have full access and control. In some exemplary embodiments, the assistance layer may be defined over a DAP or any other similar platform, and may be designed to comprise at least one content-based validation tooltip.

In some exemplary embodiments, the content-based validation tooltip may be configured with one or more guidance messages such as Guidance 330 of FIGS. 3A and 3B, one or more display conditions such as Message Display Conditions 307 of FIG. 3A, one or more success indications such as Success Indication 309 of FIG. 3A, one or more validation rules such as Validation Rules 301 of FIG. 3A, or the like. In some exemplary embodiments, the validation tooltip may be configured with one or more LLM Rules such as Validation Logic 331 of FIG. 3B, which may comprise content-based rules requiring text analysis capabilities, text generation capabilities, or the like.

In some exemplary embodiments, Page 400 may comprise a screenshot of an empty form (“Create Goal”), with a plurality of free text fields. In some exemplary embodiments, the free text fields may be intended to be filled out by end users and submitted to a server of the third-party application, the client, or the like. In some exemplary embodiments, Page 400 may comprise at least a Goal Field 411, in which the end user is expected to describe in natural language a professional goal, and Description Field 413, in which the end user is expected to provide a detailed description of the manner in which the end user wishes to implement the goal and measure its completion. In some exemplary embodiments, via the form of Page 400, end users may create a new goal, define the goal, describe the goal, categorize the goal, provide additional information, or the like.

In some exemplary embodiments, in case one or more guidance messages are defined for the tooltip, the validation tooltip may present one or more messages or visual cues before any input is submitted by end users, during input submission, or the like, such as in order to guide the end users in advance. In other cases, such as in case guidance messages or cues are not defined, the validation tooltip may be designed to present one or more messages of visual cues only after input is provided by end users. In some cases, in case a plurality of guidance messages is defined for a respective plurality of validation tooltips in a single page, the plurality of guidance messages may be presented sequentially, according to a desired order of filling out the page fields, such as by first displaying the guidance message of a first page element, and after the first page element is interacted with by the end user, the guidance message of a second page element may be displayed, and so on. In other cases, more than one guidance messages may be displayed simultaneously, e.g., all guidance messages that are defined for page elements that are displayed and visible to the end user.

For example, Guidance Message 421 may be defined for Goal Field 411, and may be presented before the end user fills out Goal Field 411, during the process, or the like. Guidance Message 421 may be displayed as an overlay of a GUI element such as a tooltip widget, a balloon widget, or the like, over or in proximity to Goal Field 411. According to this example, Guidance Message 421 may notify the end user that Goal Field 411 is mandatory and must be filled (e.g., by stating: “Please fill in this field”, or any other terminology), how to fill in Goal Field 411, what conditions should be complied with, or the like. For example, Guidance Message 421 may be written by the admin user via the DAP editor.

In some cases, mandatory fields that are not filled in may be visually indicated, in addition to or instead of Guidance Message 421, such as by changing a color of one or more GUI elements associated with Goal Field 411 to red or any other color, their border, background, or the like, by adding an asterisk symbol, or the like. In some cases, instead of presenting Guidance Message 421, one or more selectable widgets (e.g., depicted as a question mark) may be configured to display Guidance Message 421 upon a user selection or hover. In other cases, one or more selectable widgets (e.g., depicted as a question mark) may be configured to display any other assistance data.

In some exemplary embodiments, as depicted in FIG. 4B, the end user may insert into Goal Field 411 the text string: “Travel the world”, as the desired goal. In some exemplary embodiments, in response to the user input, one or more LLM rules of the validation tooltip (defined by the admin user and not shown to the user) may be executed, causing a prompt to be generated and provided to an LLM engine.

In response to the prompt, the LLM engine may respond to the validation tooltip that the input is non-compliant with the LLM rule, an associated explanation, an associated guidance, or the like. In some exemplary embodiments, the assistance layer may display to the end user an indication that the input is non-compliant, e.g., over the validate field, adjacent thereto, or the like. In some exemplary embodiments, in response to the user input, the validation tooltip may present a message to the user, such as Feedback Message 423, stating: “The response is not compliant with the requirement as it does not describe a goal for improving performance or developmental skills”, as depicted in FIG. 4C. For example, the text of Feedback Message 423 may comprise an explanation that is dynamically generated by the LLM engine to describe why the user input violated the validation rule and was determined to be non-compliant, and is not written by an admin user. As another example, the text of Feedback Message 423 may be generated based on a combination of the LLM engine and a set of pre-configured responses.

In some exemplary embodiments, the end user may adjust their input in response to Feedback Message 423, e.g., as depicted in the scenario of FIG. 4D, causing the LLM rules of the validation tooltip may be re-executed. For example, in the scenario of FIG. 4D, the end user may insert into Goal Field 411 the text string: “Improve my coding skills”, the validation rules may be executed over the provided value, causing a second prompt to be generated and provided to an LLM engine (one or more same or different LLM engines than those used for the string “Travel the world”). In response to the prompt, the LLM engine may provide to the validation tooltip an indication that the input is non-compliant with the LLM rule in the prompt, an associated explanation, an associated guidance, or the like. For example, in response to the user input, the validation tooltip may present a message to the user, such as Feedback Message 425, stating: “The response is relevant but not specific enough”, as depicted in FIG. 4D. For example, Feedback Message 425 may be based on the output from the LLM engine, and may not be manually scripted.

In some exemplary embodiments, the end user may adjust his input according to the obtained instructions and/or content-based feedback, until the user input is validated by the validation rules, is determined by the LLM engine to comply with the LLM rules, or the like. For example, FIG. 4E depicts a scenario in which, in response to Feedback Message 425, the user updated the text string to state: “Improve my coding skills by learning new testing frameworks”. Similarly to the first two text strings from the user, this text string may be processed by the LLM engine, compared to the LLM rule, and an output from the LLM engine may be provided to the validation tooltip. For example, the LLM engine may indicate that the text string complies with the validation rules.

In some exemplary embodiments, in response to determining that the validation rules are complies with, the validation tooltip may or may not provide a success indication, e.g., based on whether or not the admin user defined a success indication to be presented to the end user. For example, in the scenario of FIG. 4E, the success message “All is good” may be displayed.

In some cases, the assistance layer may define that upon successful completion of a task associated with a tooltip, a subsequent tooltip associated with a next field in the order of the form may be activated, causing respective messages to be displayed. For example, since the tooltip of Goal Field 411 was successfully executed, the tooltip of Description Field 413 may be activated, causing one or more guidance messages to be presented in case they are defined by the tooltip. For example, in the scenario of FIG. 4E, Guidance Message 433 may be displayed, stating: “Please fill in this field” in proximity or over Description Field 413. In other cases, any other messages may be defined by the admin user and presented to the end user instead of Guidance Message 433. For example, FIG. 4F depicts replacing Guidance Message 433 with Guidance Message 434, which states: “This is where you Will enter the details of your goal. How will you measure success? Are there multiple pieces to the overall goal that can be tracked throughout the year?”, which may comprise more concise guidance than Guidance Message 433 for filling out Description Field 413.

It is noted that in some embodiments, instead of requiring the admin user to write guidance messages, the editor may enable the admin user to leverage existing guidance messages, e.g., in a semi-automated manner. In some exemplary embodiments, existing guidance messages may be available for a specific client of the DAP, based on previously-defined guidance messages of the client. In some exemplary embodiments, existing guidance messages may be available for across clients of the DAP, based on previously-defined guidance messages of the different clients, defined by entities associated with the DAP, or the like. In some exemplary embodiments, such legacy guidance messages may convey to end users the purpose and meaning of the respective field. For example, Guidance Message 434 of FIG. 4F may comprise a legacy guidance message defined by a user other than the admin user, and selected by the admin user to be implemented.

In some cases, the DAP may automatically utilize the legacy guidance messages as an LLM rule, such as by generating a prompt that asks the LLM engine whether input from an end user complies with a legacy guidance message. For example, the following prompt may be generated: “The following guidance was included for this field [legacy guidance message]. On a scale of 0-5 how is “[input field]” compliant with this guidance?”. In some cases, in case there are multiple alternative guidance messages for a same field, such as for different user segments, the guidance message that matches the end user may be used for the prompt.

In some exemplary embodiments, the end user may attempt to fill out Description Field 413, such as according to the instructions of Guidance Message 433, Guidance Message 434, or the like. For example, in the scenario of FIG. 4G, the end user may input to Description Field 413 the text string: “Learn new coding language”, as the description of the desired goal. In some exemplary embodiments, in response to the user input, one or more validation rules of the validation tooltip of Description Field 413 may be executed, causing a prompt to be generated and provided to an LLM engine (one or more LLM engines that may or may not correspond to the LLM engine used for Goal Field 411).

In response to the prompt, the LLM engine may respond to the validation tooltip that the input is non-compliant with the LLM rule, an associated explanation, an associated guidance, or the like. For example, in response to the user input, the validation tooltip may present a message to the user, such as Feedback Message 441, stating: “The response only partially addresses the requirement. It describes a goal to learn a new coding language but does not provide details on how success will be measured”, as depicted in FIG. 4G. For example, Feedback Message 441 may be based on the output from the LLM engine, and may not be scripted by the admin user.

In some exemplary embodiments, the end user may adjust his input according to the obtained instructions and/or content-based feedback, until the user input is validated by the validation rules. For example, FIG. 4H depicts a scenario in which, in response to Feedback Message 441 or any other message, the user updated his input text string to state: “Learn new coding language. The success will be measured by finishing an online course and developing an application using the new language”. This text string may be processed by the LLM engine, and an output from the LLM may be provided to the validation tooltip. For example, the LLM engine may indicate that the text string complies with the validation rules.

In some exemplary embodiments, in response to determining that the validation rules are complies with, the validation tooltip may or may not provide a success indication, e.g., based on whether or not the admin user defined, for the validation tooltip of Description Field 413, a success indication to be presented to the end user. For example, in the scenario of FIG. 4H, the success message “All is good” may be displayed to the end user.

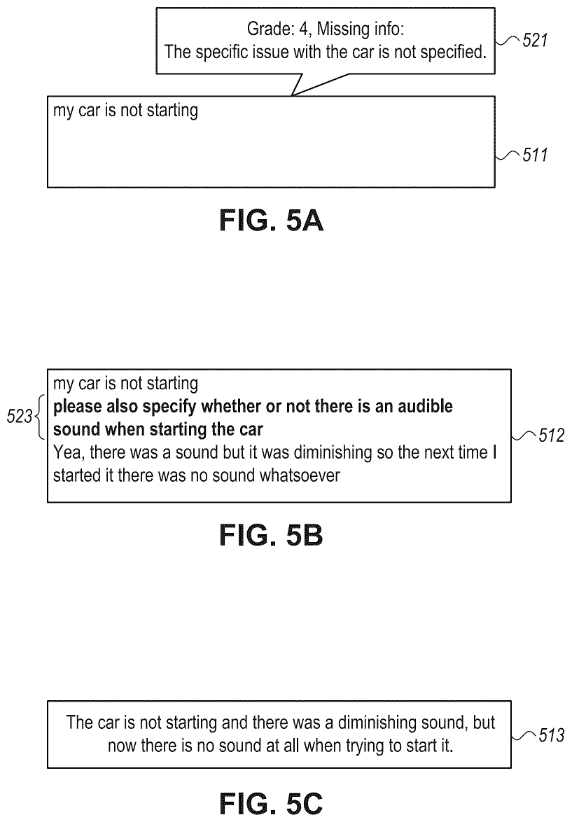

Referring now to FIGS. 5A-5C showing exemplary scenarios of user interactions with a deployed validation tooltip, in accordance with some exemplary embodiments of the disclosed subject matter.

In some exemplary embodiments, a validation tooltip may be deployed in association with a field in a page of a third-party application, such as Field 511 of FIG. 5A. For example, Field 511 may be intended, by the third-party application, for obtaining detailed information from a user about problems with their car. In some exemplary embodiments, in case the user inputs the text string “my car is not starting” into Field 511, the validation rules of the respective tooltip may be executing thereover. For example, the execution of the rules may cause a prompt to the LLM engine to be generated, which instructs the LLM engine to determine whether the LLM rules were violated or complied with, to provide a grade of success of the user input (e.g., in which 5 means the response is fully compliant with the above requirement and 0 means it is totally irrelevant), to provide feedback on inputs from end users, or the like.

For example, in the scenario of FIG. 5A, the LLM engine may estimate that the user input violates the validation rules, resulting with a feedback message such as Feedback Message 521 being obtained from the LLM engine and displayed as an overlay over the page. For example, Feedback Message 521 may be presented within a widget (e.g., GUI element) such as a callout balloon or tooltip, on top of Field 511 or adjacently thereto, e.g., similarly to the messages in FIGS. 4A-4H. In some cases, Feedback Message 521 may state: “Grade: 4, Missing info: The specific issue with the car is not specified”, or any other message indicating that the input is not compliant, providing suggestions for adjusting the input, or the like.

In some exemplary embodiments, in order to enhance the user experience, the validation tooltip may employ a chat widget such as a Chatbot to communicate with the user via the LLM engine. For example, a Chatbot may be deployed to provide output messages and obtain input messages from the end users, instead of iteratively extracting user input (“my car is not starting”) from Field 511, obtaining feedback to the user input from the LLM engine, and presenting a message to the end user according to a response from the LLM engine. In some exemplary embodiments, a chat widget may be utilized to chat with the end user using natural language, showing previous user inputs and LLM-generated feedback as messages of a conversation in the chat widget.

For example, Chatbot 512 of FIG. 5B may comprise a chat widget deployed for Field 511 (by the tooltip or assistance layer), presented as an overlay (e.g., a balloon element) over the page of the third-party application, as a separate page, or the like. For example, Chatbot 512 may be presented over Field 511 (e.g., hiding Field 511), adjacent to Field 511, or the like. In some exemplary embodiments, Chatbot 512 may be configured to obtain user messages that are intended to be used as input for Field 511, generate prompts based thereon, and provide feedback from the LLM engine as an answer in the conversation.

In some cases, the prompts used for Chatbot 512 may be adjusted to match a natural language interface, e.g., instead of reciting “Grade: 4, Missing info: The specific issue with the car is not specified”, which is not be natural language, Chatbot 512 may provide Feedback Message 523 which recites “please also specify whether or not there is an audible sound when starting the car”, or similar messages that are in natural language (e.g., corresponding to potential human conversation). For example, the prompt may be adjusted to instruct the LLM engine to provide feedback in natural language, feedback that matches a conversation of a Chatbot, or the like. In some exemplary embodiments, a subsequent input from the user, such as: “Yeah, there was a sound but it was diminishing so the next time I started the car there was no sound whatsoever”, may be presented in Chatbot 512, and used to generate a prompt to the LLM engine, until the LLM rule is determined to be complied with by the conversation of Chatbot 512.

In some exemplary embodiments, when generating a prompt, Chatbot 512 may utilize the entire conversation as the input (e.g., within the dynamic portion of the prompt), and the prompt may instruct the LLM engine to determine whether the input complies with the LLM rule. In some cases, prompts to the LLM engine may be generated to comprise each user message, concatenated messages of the entire conversation, or the like. For example, every time the user provides input, the validation rules may be executed over the entire chat, and not only over the last user input. For example, the prompt to the LLM engine may state: “Please create a response that is compliant with the fill requirement “[FILL-REQUIREMENT] based on the following information the user has provided: “[FIELD VALUE]”, “[CHAT-RESPONSE₁]”, “[CHAT-RESPONSE₂]”, . . . , “[CHAT-RESPONSEₖ]””. In other cases, the prompt may be generated to incorporate a portion of the conversation, the last entered input, any other portion of the conversation, or the like.

In some exemplary embodiments, in case the conversation is not validated, the feedback from the LLM engine may be provided as a next message in Chatbot 512. In some exemplary embodiments, in case the conversation from Chatbot 512 is determined by the LLM engine to comply with the LLM rule, the LLM engine may be instructed to provide a summary of the conversation, of the detailed provided by the user in the conversation, or the like, thereby automatically generating a proper input for Field 511 based on the conversation with the end user. For example, Input 513 of FIG. 5C may be generated by the LLM engine as a proper input for Field 511. For example, according to the scenarios of FIGS. 5A and 5B, Input 513 may be generated to state: “The car is not starting and there was a diminishing sound, but now there is no sound at all when trying to start it”, in case this data is determined to comply with the LLM rule of the tooltip.

In some exemplary embodiments, Input 513 may be provided to the end user to be manually entered to Field 511, or may be automatically entered into Field 511 by the automation process of the validation tooltip. For example, the automation process may identify Field 511 in the page using one or more acquisition processes, and enter Input 513 thereto, potentially enabling the end user to adjust the text of Input 513.

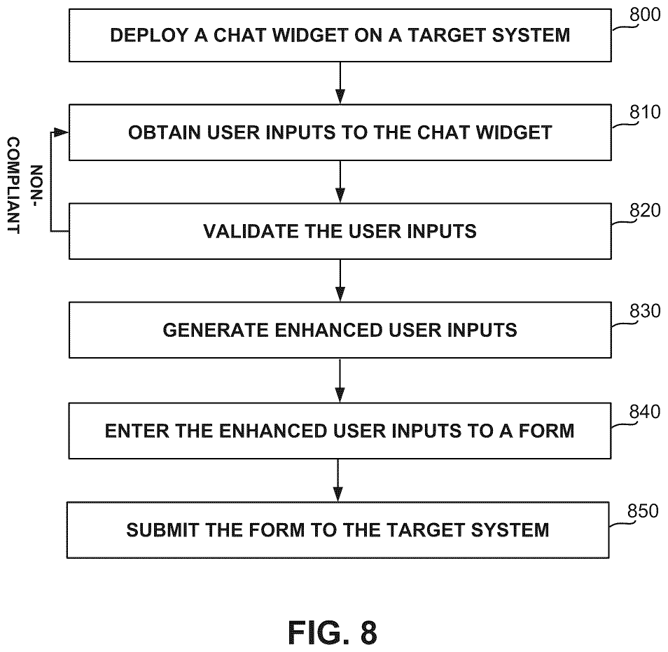

In some exemplary embodiments, tooltips may utilize chat widgets to obtain compliant inputs to fields in pages of third-party application, e.g., according to the method of FIG. 8. In some cases, a tooltip that is defined in a page-level granularity may utilize a chat widget to obtain compliant inputs to a plurality of page fields, e.g., via a same chat widget. In some cases, tooltips that are defined in field-level granularity may share a chat widget that

Referring now to FIG. 6 showing a flowchart diagram of a method in accordance with the disclosed subject matter.

On Step 600, a non-programmer human administrator user (also referred to as “builder” or “admin”) may execute an editor software of a digital adoption platform over an end device, e.g., a computer. In some exemplary embodiments, the admin may utilize the editor of the digital adoption platform to set configurations of an assistance layer from building blocks provided by the editor (e.g., DAP building blocks such as tooltips).

In some exemplary embodiments, the assistance layer may be configured to be executed over a form or any other page of a target system. In some exemplary embodiments, the target system may comprise a third-party system, such as a web-based system, a native system, a mobile system, or the like. In some exemplary embodiments, the assistance layer may be configured to augment and enhance the target system with additional functionality, perform data collection, provide additional data, or the like. In some exemplary embodiments, the assistance layer may be set to monitor, enhance and augment one or more target systems that are involved in a digital task associated with an organization to which the admin belongs. For example, the digital task may comprise a cross-system business process, a single system business process, or the like.

In some exemplary embodiments, the admin may generate the assistance layer to comprise, amongst other building blocks, at least one validation tooltip for a selected field in a form or any other page of the target system (e.g., the third-party application).

On Step 610, the admin may select configurations for the validation tooltip, such as one or more validation rules for user input inserted to the selected page field. In some exemplary embodiments, the editor may enable the admin to select validation rules from a list of pre-configured rules, to write an LLM rule using free text in natural language, or the like.

On Step 620, upon setting the validation rule for the validation tooltip, the validation rule may be stored by the digital adoption platform.

In some exemplary embodiments, the validation rule may be stored as part of an executable assistance layer that can be executed over a plurality of end devices. For example, a plurality of end users (e.g., employees and/or customers of the organization, different from the admin) that attempt to perform the digital task on their end devices, may be enabled to execute the assistance layer over their end devices simultaneously.

In some exemplary embodiments, the assistance layer may be distributed to the end devices, embedded in the pages of the digital task, or made accessible to the end devices in any other way. In some exemplary embodiments, the assistance layer may be implemented at end devices as a browser extension, as a dedicated browser of the digital adoption platform, as client-side code in the web-based target system itself (e.g., an “include” directive that is configured to provide the enhancements), or the like.

On Step 630, an end user executing the target system and the assistance layer may reach the selected field in the page in the target system, for which the validation tooltip is defined. In some exemplary embodiments, the assistance layer may monitor, enhance and augment the target system, such as based on which GUI elements of the target system are visible on the screen of the end device, user input to the GUI, an address of the page, or the like. For example, in a web-based system, a URL in which the page is displayed may be monitored by the assistance layer and determined to be reached when matching a previously stored URL.

On Step 640, one or more configurations or settings of the validation tooltip may be retrieved from the DAP or the assistance layer and executed, activated, or the like, e.g., in response to identifying a trigger event of the tooltip. In some exemplary embodiments, the execution of the assistance layer may comprise at least an execution of the validation rules of the tooltip.

In some exemplary embodiments, the trigger event may be identified in case that the end user reached field in the target system for which the validation tooltip is defined, in case the end user hovered over the field or selected the field, in case the end user entered data to the field, or the like.

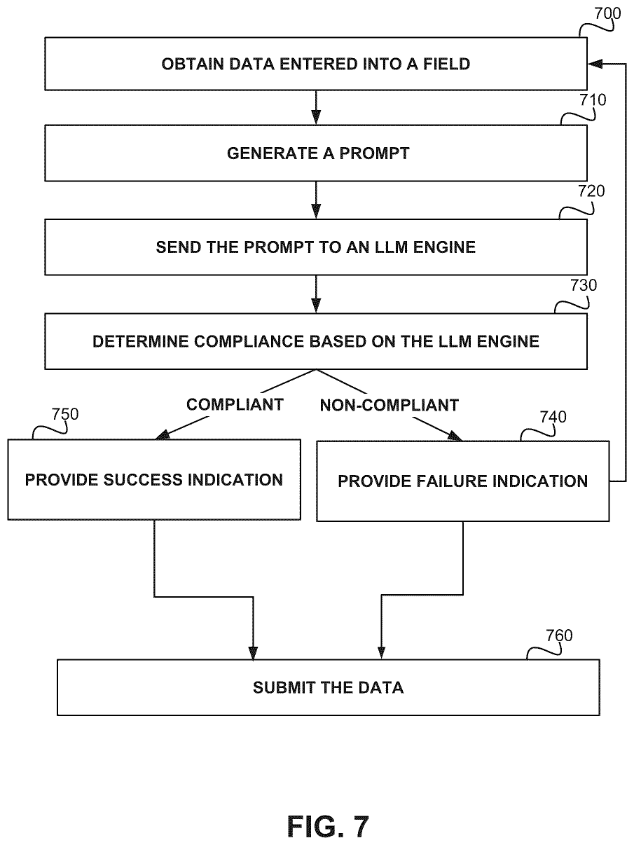

In some exemplary embodiments, input inserted to the selected field by the end user may be validated by a retrieval and execution of the validation rule of the validation tooltip, e.g., stored by Step 620. For example, the input may be validated using a validation rule that makes use of prompts to an LLM engine, e.g., according to the method of FIG. 7. In some exemplary embodiments, a result may be generated by the tooltip based on an output from the LLM engine, and presented to the end user in one or more messages, chat widgets, overlays, or the like.

Referring now to FIG. 7 showing a flowchart diagram of a method in accordance with the disclosed subject matter.

On Step 700, data that an end user entered into a field may be obtained. In some exemplary embodiments, the end user may enter the data into a field in a target system. In some exemplary embodiments, the field may comprise a field for which an admin user defined, previously, a validation tooltip with a validation rule. For example, an admin user may define the validation rule according to Step 610 of FIG. 6. As another example, the admin user may define the validation rule using regular expressions, syntactical constraints, natural language free text, or the like.

For example, an admin user of an opera may define a validation rule for the field, as part of an assistance layer that is configured to assist end users with purchasing a ticket to opera shows, or to assist end users with any other digital task. According to this example, an end user may access one or more target systems (belonging to the opera or to a third-party service) to purchase a ticket to an opera show, while executing the assistance layer over the target systems. In some exemplary embodiments, the assistance layer may monitor the user interactions, and determine that a trigger event defined by the tooltip occurred, e.g., the user entered data to the field.

On Step 710, in case the validation rule of the field includes an LLM rule, the assistance layer may generate a prompt for an LLM engine, in response to obtaining the data from the user. In some exemplary embodiments, the prompt may be generated based on the entered data, predefined rules, or any other configurations of the validation tooltip. In some exemplary embodiments, the prompt may be designed to be used for determining whether the entered data complies with the validation rule, to provide suggestions to the end user for enhancing the input to the field, or the like.

In some exemplary embodiments, the prompt may be generated to comprise a static portion, a dynamic portion, a combination thereof, or the like. In some exemplary embodiments, the prompt may be generated to populate the dynamic portion with the input to the field, with other page data, or the like. In some exemplary embodiments, the prompt may be generated to comprise, at least, the data that was entered into the field and obtained on Step 700. In some cases, the data may comprise text that the user entered to the field, and in such cases, the text may be quoted or incorporated at least in part within the prompt. In some cases, the data may comprise any other user input, character, or the like, and the prompt may be generated to incorporate such input accordingly.

In some cases, the prompt may be generated to include contextual information conveying a context of the page around the field, such as field names and values of other fields in the page, information regarding other inputs the end user has provided to the target system, information regarding validation rules of other fields in the page or target system, information gathered from the target system, or the like. For example, the contextual information may comprise a dynamic portion of the prompt that differs for different prompt generations, e.g., every trigger event.

In some exemplary embodiments, the prompt may be generated to utilize, as the static portion of the prompt, an instruction to validate an LLM rule according to the dynamic portion of the prompt, to provide certain feedback, to utilize a specific format for the output, or the like. For example, the instruction may comprise one or more general statements regarding the background of the task, a preferred format for the answer, general instructions that apply for different validation tasks, or the like.

In some exemplary embodiments, after the admin user defined an LLM rule, the LLM rule may be incorporated in the prompt as part of the static portion, and used statically for respective end users. For example, end users that execute the assistance layer generated by the admin user may all invoke a prompt with the same LLM rule, in response to the trigger event of the field, while the dynamic portion may vary between different end users.

In some cases, instead of defining an LLM rule from scratch, one or more LLM rules may be generated by selecting them from a set of pre-defined LLM rules. For example, an admin user may select, for a page field, a pre-configured validation rule of “valid email address”, which may be associated or translated into prompt text such as: “a valid email address from the form user@domain, where the domain is a valid domain name and has an active MX record in the domain name server”, or “a valid email address in accordance with RFC 2822”. According to this example, the text may be incorporated into the prompt as is, or may be adjusted by the admin user.

On Step 720, after the defined prompt is generated with the user's data, the assistance layer may provide the prompt to the LLM engine. In some exemplary embodiments, the LLM engine may process the prompt and generate one or more outputs, responses, or the like, based on the prompt.

In some cases, the LLM engine may be fine-tuned for one or more specific applications, digital tasks, formats, or the like. For example, the LLM engine may be fine-tuned with a specific roleplaying instruction, such as “imagine you are an assistance ensuring compliancy of users' input into the system”. In other cases, the roleplaying instruction may be included in the generated prompt, without necessarily fine-tuning the LLM engine. In some exemplary embodiments, roleplaying may be useful for providing contextualization (e.g., generating responses that align with a desired context), expertise emulation (e.g., generating responses that reflect domain-specific expert knowledge), enhanced engagement, target information (e.g., causing the model to generate responses the specifically address the needs or questions of the given role), or the like. As another example, the LLM engine may be find-tunes to always use a specified format.

In some exemplary embodiments, based on the prompt, the LLM engine may generate one or more outputs, responses, or the like. For example, the LLM engine may generate a response to the prompt, indicating whether the data the end user entered is compliant with the LLM rule, what is wrong with the data, or the like. In some cases, the response may include additional data in addition to an indication of compliance. As an example, the response may provide a message to present to the end user in case of no compliance, such as a message providing assistance and guidance to the end user, a suggested output response to the end user explaining why the data is non-compliant, a message explaining how the user should update the data, or the like.

In some exemplary embodiments, in case the prompt specified a format for the response, or the format was specified as part of a fine-tuning stage, the LLM engine may provide the response in the specified format. For example, the response from the LLM engine may be provided in a format such as JavaScript Object Notion (JSON), eXtensible Markup Language (XML), or the like.

On Step 730, the assistance layer may determine whether or not the input entered by the end user complies with the validation rule of the validation tooltip, based on the output from the LLM engine. In some exemplary embodiments, the compliance may be determined based on the response from the LLM engine. For example, the LLM engine may be configured to provide an indication, a grade, or the like, indicating whether the user's data is compliant, and the validation tooltip may measure the indication to determine whether the data is compliant. In some exemplary embodiments, the flow of the method may continue to Step 750 in case the data from the end user is determined to be compliant with the validation rule, and to Step 740 in case the data is determined to violate the validation rule.

On Step 750, in case of a compliant determination, one or more success indications may be provided to the end user. For example, success indications may comprise an output indicating successful validation using a color indication, a change of format, a text indication (predefined by the admin user or provided from the LLM engine), or the like. For example, the success indication may include a callout balloon indicating “all is well”, “passed content validation”, “your input is great”, “you input is compliant with our requirements”, or the like, e.g., similar to FIG. 4E.

On Step 740, in case of a non-compliant determination, one or more failure indications may be provided to the end user. For example, an output may be provided to the end user indicating the data is non-compliant using a color indication, a change of format, a text indication (predefined by the admin user or provided from the LLM engine), or the like. In some cases, in case the data violates the validation rule, the assistance layer may engage in an on-screen interaction with the user, in which a failure indication may be presented, mentioned, explained, or the like. For example, the failure indication may comprise a red marking around the field, an asterisk symbol adjacent to the field, or the like.

In some cases, in addition to a failure indication, or instead thereof, the assistance layer may serve to the end user content-based feedback, such as an explanation why the data is non-compliant, a suggestion how the end-user may improve the data to make it compliant, or the like. For example, the content-based feedback may be similar to those of FIGS. 4C, 4D and 5A-5B.

In some exemplary embodiments, the failure indication and/or content-based feedback may be served to the end user within the layout of the page, in one or more overlays above the page, or the like. For example, the failure indication and/or content-based feedback may be served to the end user within a text message overlay, a chat widget, or the like.

In case a chat widget such as a mini-chat GUI or chatbot is utilized to convey the message to the end user, a natural language conversation (e.g., using NLP processing) may be implemented between the chat widget and the end user to allow the end user to improve the data that was filled in the field. For example, a first message from the chat widget may correspond to the failure indication and/or content-based feedback described above, a next user input may be obtained from the end user via the chat widget and processed by the LLM engine, and a subsequent response from the chat widget may correspond to an output from the LLM engine, e.g., iteratively. For example, FIG. 8 may correspond to the use case of a chat widget.

In some exemplary embodiments, in response to the failure indication and/or feedback of Step 740, the end user may adjust or update their data input, thereby redirecting the flow to Step 700. In other cases, the end user may not adjust their input, and the method may continue to Step 760, e.g., in case they disagree with the presented feedback, decide that the LLM engine is mistaken, or for any other reason.

On Step 760, the end user may submit the data, e.g., after filling out all fields in the page, a portion of the fields, or the like. For example, the previous steps may be implemented iteratively for each field for which a tooltip with a validation rule (e.g., an LLM rule) is defined within a single page or form, until all fields are filled out properly.

In some cases, data may be submitted only after all validation tooltips in the page determine compliance of the values that were provided to the fields from the end user with their validation rules. For example, the assistance layer may block the option of submitting a form in case of violated validation rules, such as by placing an overlay over a ‘submit’ button. In some cases, data may be submitted to the target system even in case that one or more validation rules are determined to be violated by the user input. For example, in case the end user does not wish to change their input to a field, they may ignore or override the failure indication and/or feedback, and submit a form in which one or more failure indications are presented.

In some exemplary embodiments, the end user may select to submit a form or page in which at least some of the fields are filled out, by selecting a “submit” button, providing a voice command, or activating a similar control.

In some cases, in case an end user ignored a failure indication, this incident may be recorded as an event (e.g., by the assistance layer) and provided to an admin user or another user (also referred to as a reviewer) for review. In such cases, the admin user may review records of the event, such as feedback that was served to the end user and ignored, the user's input to the respective field, or the like. In other cases, in addition to or instead of the manual review, an automatic filtration of overriding activity may be performed, such as based on heuristics. In some exemplary embodiments, the reviewer may manually review the event information to decide whether the decision of the end user to override the decision of the LLM engine was proper, whether the input was in fact compliant with the validation rule, whether the LLM's response was a false negative, or the like. In some cases, in case the input is estimated by the admin user to be compliant, the admin user may or may not suggest edits to the validation rule, the prompt configurations, or the like, in order to ensure future LLM feedback will be more accurate. In other cases, such as in case the input was in fact incorrect and the LLM feedback was correct, the admin user may not adjust the system's settings, may contact the end user to request corrected input, or the like.

In some exemplary embodiments, in case the reviewer determines that the LLM feedback was a false negative, the validation rule may be adjusted manually, automatically, or the like. For example, an automatic adjustment may be performed by configuring a prompt to the LLM engine to include the original validation rule, the responses that were mistakenly determined to be non-compliant, and an instruction to update the validation rule so that such responses will be compliant in the future. As an example, a prompt may be “consider the following fill requirement for a field named [FIELD-NAME]: “[FILL-REQUIREMENT]”, Suggest an updated fill requirement so that the following responses are considered fully compliant with the above requirement [OVERRIDEN-RESPONSE₁], [OVERRIDEN-RESPONSE₂], . . . [OVERRIDEN-RESPONSEₙ]”. In some cases, non-compliant responses may also be gathered and provided to the LLM engine to ensure that the update would not cause such data to be mistakenly considered as compliant. As an example, a prompt may also include the following: “The updated fill requirement should consider the following responses as not fully compliant [RESPONSE₁], [RESPONSE₂], . . . , [RESPONSEₘ]”.

Reference is now made to FIG. 8, showing an exemplary flowchart diagram of a method, in accordance with some exemplary embodiments of the disclosed subject matter.

On Step 800, a chat widget, such as a chatbot, mini-chat or chat module, may be deployed and utilized for communicating with the end user. For example, instead of communicating with the end user via messages that are presented in response to each user input to the field for which the validation tooltip is defined, the communications and user inputs may be provided as part of a natural language conversation between the end user and the assistance layer, via the chat widget. In some cases, the chat widget may be utilized in addition to or instead of the end user providing input to one or more fields. For example, some information may be inserted by the end user directly to page elements while other information may be inserted via the chat-modality.

In some exemplary embodiments, the chat widget may implement a natural language conversation with an end user. In some exemplary embodiments, one or more chat widgets may be used to iteratively analyze and provide feedback to inputs provided by an end user to a field, until the accumulated input is determined to comply with the validation rules of the tooltip. For example, the chat widget may be utilized similarly to the scenario of FIG. 5B, and to the natural language conversation disclosed by U.S. Pat. No. 10,819,664 “Chat-Based Application Interface For Automation”, dated Oct. 27, 2020.

In some exemplary embodiments, the chat widget may be implemented as an overlay over a page of the third-party application (e.g., a form), may be embedded within the page, or the like. In some exemplary embodiments, the chat widget may be presented adjacently to the field, on top of the field (e.g., partially or fully hiding the field), or the like. In some exemplary embodiments, the chat widget may be displayed as an overlay over the form, such as a hovering module that is shown on the bottom right-side of the web page being displayed to the user, in the middle of the screen, in a non-anchored location (i.e., that does not remain constant when the user scrolls the page), in other corners of the page, or the like. In some cases, the chat widget may be implemented externally from the page, such as enabling the end user to fill out the page fields without navigating to the page.

On Step 810, one or more user inputs to the chat widget may be obtained. For example, instead of filling out the field directly, a chatbot may be used to obtain the user inputs to the field, and invoke an automation process to fill out the field according to the user's inputs upon determining compliance with a validation rule.

In some cases, the chat widget may be utilized for two or more fields in one or more pages. For example, instead of filling out the fields in the one or more page, the end user may provide user inputs for the fields to the chat widget, the chat widget may converse with the end user until the user inputs comply with respective validation rules of validation tooltips defined for the two or more fields, and the compliant inputs (or summary thereof, portion thereof, or the like) may be provided to the tooltips to be automatically populated.

In some exemplary embodiments, the end user may provide to the chat widget inputs for filling out one or more fields of a page as a single chat message, or via sequential messages of a conversation with the chatbot. For example, the end user may instruct the chatbot to: “Add a new lead named John Smith with email john@smith.com, from NYC. He is interested in buying 10,000 units by September”. As another example, the data may be provided in a step-by-step manner, e.g., as follows:
User: Add a new lead
Assistant: What is the lead's name
User: John Smith
Assistant: What is John Smith's contact information?
User: john@smith.com
Assistant: what is John Smith interested in?
User: Buying 10,000 units by September.
Assistant: is that all or do you have additional information to add?
User: That's all.

According to this scenario, the chatbot may ask the user to provide information for all mandatory fields in the relevant form, for non-mandatory fields as well, or the like. In some exemplary embodiments, the chat widget may determine which fields are important based on statistical information available on the digital adoption platform, and input for these fields may be requested from the end user. For example, the chat widget may select the fields based on statistical information indicating that ends users (in general, or from a user segment similar to the current end user) often input information into non-mandatory fields (e.g., above a predetermined relative threshold such as over 20%, 30%, 40%, or the like), fields in which end users often encounter validation issues, fields in which end users spend the most time filling-in information, or the like. For example, the chat widget may be configured to suggest to the end user to provide inputs to popular fields (in general, with respect to similar end users, with respect to end users that provided similar information to other fields, or the like). As another example, the chat widget may provide a more detailed explanation about fields that have relative high validation failure rates (e.g., above a predetermined threshold) compared to other fields.

On Step 820, after the end user provides to the chat widget inputs for one or more page elements, fields, or the like, the inputs may be validated. For example, the inputs may be validated at one or more LLM engines. In some cases, the validation may be invoked in view of one or more trigger events being identified, e.g., in case information is entered into the GUI, the chat widget, or the like. In some exemplary embodiments, in order to validate the inputs, the chatbot may provide the obtained information to one or more tooltips defined for the page elements. For example, the chatbot may provide the entire conversation, a portion thereof, contextual information, or the like.

In some exemplary embodiments, in case the chat widget relates to a single field, the chat widget may provide the conversation to the tooltip of the field, and the tooltip may generate a prompt to an LLM engine to incorporate the conversation. In this scenario, the tooltip may send the prompt to the LLM engine, and obtain a validation result from the LLM engine. In case the validation result is negative, indicating that the user input is not compliant with the LLM rule, content-based feedback from the LLM rule may be presented to the user within the chat widget. In some exemplary embodiments, Steps 810-820 may be performed iteratively, enabling the end user to adjust their input until the conversation is determined to be compliant with the LLM rule, in which case the flow of the method may continue to Step 830.

In some cases, the chat widget may relate to a plurality of page fields. In such case, the chat widget may interface with a plurality of field-level tooltips of each field, or the chat widget may interface with a single page-level tooltip defined for the plurality of fields.

In some exemplary embodiments, in case of field-level tooltips, each tooltip may obtain the conversation from the chat widget, generate a prompt to an LLM engine to incorporate the conversation, send the prompt to the LLM engine, and obtain a validation result from the LLM engine. In some exemplary embodiments, non-compliant results may cause the tooltips to provide content-based feedback (from the LLM engine) to the chat widget, for presenting the feedback to the end user. In some exemplary embodiments, the end user may be enabled to respond to the content-based feedback of each field, until all LLM rules are complied with. For example, each content-based feedback that is presented to the end user may invoke Step 810 iteratively, until no more content-based feedbacks are provided from the LLM for any of the fields. The flow of the method may continue to Step 830 in such case.

In some exemplary embodiments, in case of a page-level tooltip, the tooltip may generate a prompt to an LLM engine to incorporate the conversation, send the prompt to the LLM engine, and obtain a validation result from the LLM engine. In some exemplary embodiments, a page-level tooltip may be configured to generate a prompt that comprises separate LLM rules for respective fields, or to generate a prompt that comprises page-level LLM rules with which all fields must comply.

In some exemplary embodiments, an LLM engine may be utilized to analyze the content of the conversation, and apply one or more validation rules on the content to determine compliance with the validation rules. For example, an LLM engine may determine which portion of the conversation relates to which page field, and determine compliance of that portion with the respective LLM rule of the prompt. In other cases, an LLM engine may determine compliance of the entire conversation with the respective LLM rule.

In some cases, instead of generating prompts for each field separately by each tooltip, a page-level tooltip may be configured to generate a prompt that incorporates, for a plurality of fields of the page, respective indications of whether the fields are mandatory, validation requirements of the fields, field labels, or the like. According to this scenario, the LLM engine may determine compliance of all the plurality of fields at once, and provide respective outputs to the page-level tooltip. For example, the output may indicate that one or more first user inputs to respective fields are compliant with their LLM rules, that one or more second user inputs to other fields are not compliant with their LLM rules, content-based feedback to the second user inputs, or the like. In such cases, the tooltip may provide the content-based feedback to the chat widget, enabling the chat widget to present the content-based feedback to the end user.

In some cases, in order to enhance the level of the content-based feedbacks, the LLM engine may be provided with the statistical information of the respective fields, such as to inform the LLM engine which fields are more difficult for end users to fill out properly, what are typical errors of users, or the like. In some cases, the outputs of the validation process, as provided by one or more LLM engines, may be provided to the chat widget by the assistance layer, from one or more respective tooltips, by extracting the outputs from the GUI, or the like.

In some exemplary embodiments, during each iteration of Steps 810-820, new user inputs may be provided to the chat widget, and, in response, one or more updated prompts may be generated (e.g., by one or more tooltips) and sent to the LLM engine(s) to determine compliance, to provide content-based feedback thereto, or the like.

On Step 830, in case the conversation is determined to be compliant with one or more LLM rules of one or more respective fields, and no inputs to fields are determined to be non-compliant, the LLM engine may be configured to generate one or more enhanced user inputs to the respective fields.

For example, once the information from the chat is sufficient to be compliant with all fields, the LLM engine may be utilized to summarize the information into respective field inputs that may be entered to the respective fields. In other cases, any other text generation task may be performed to generate the field inputs, such that each field input complies with a respective LLM rule, such that all the field inputs comply with a page-level rule, or the like.

On Step 840, the generated one or more field inputs may be used to automatically populate the respective fields. For example, one or more automation processes of respective tooltips may obtain one or more enhances field inputs, and enter such inputs to the respective fields via the GUI of the target system. In some cases, automation processes may be configured to input data into fields of the GUI by simulating a user interacting with the GUI, and without relying on an Application Programming Interface (API) of the target system. In other cases, generated input data may be provided into fields of the GUI in any other way.

In some cases, for each field, the assistance layer may simulate an interaction with the GUI of the target system to select the field (e.g., to “focus” on the field) and to input the generated value into the field. For example, user-interaction with the GUI of the target system may be simulated without user involvement to update the value. In other cases, the chat widget may provide to the end user an input for each field, and the end user may be enabled to manually enter the respective input to each field (e.g., using copy and paste functionality).

On Step 850, after filling out the fields of the page (e.g., depicting a form), the page may be submitted to the target system. In some cases, a submit button or another user interaction (e.g., a voice command) may cause the form to be submitted. The form may be submitted by the assistance layer invoking the submit button using a simulated user interaction with the GUI, by a manual interaction of the end user, or the like.

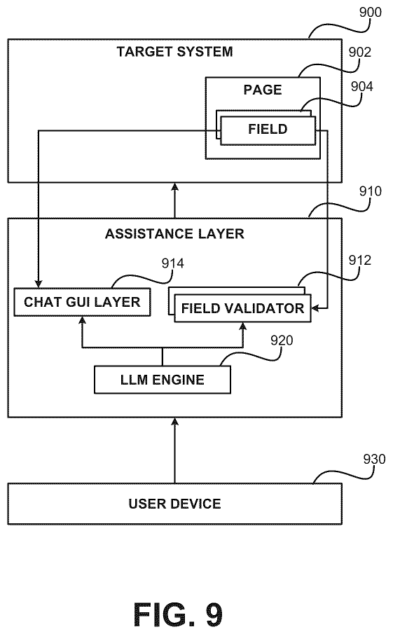

Referring now to FIG. 9 showing a schematic illustration of an exemplary architecture in which the disclosed subject matter may be utilized, in accordance with some exemplary embodiments of the disclosed subject matter.

In some exemplary embodiments, Target System 900 may be any third-party target system, such as SaaS platforms ServiceNow™, SalesForce™, Microsoft Dynamics 365™, SuccessFactors™, Workday™, Liveperson™, Jira™, SharePoint™, NetSuite™, TalentSoft™, or the like. For example, Target System 900 may comprise a bank application, a website listing opera performances, or the like.

In some exemplary embodiments, Target System 900 may define a Page 902 such as a form that has one or more Fields 904 such as text fields (e.g., for performing a bank transaction, buying a ticket, or the like). Page 902 may have a visual representation that is displayed to the end user on a screen of the end user's User Device 930. In some cases, Target System 900 may enable the end user to interact with Page 902 via User Device 930 in one or more different modalities. In some exemplary embodiments, Page 902 may enable the end user to input information into Fields 904 and to send such information to Target System 900 for processing. In some cases, Page 902 may be associated with client-side functionalities, with server-side functionalities, or the like. As an example, Page 902 may be utilized to create a new entity in a database of Target System 900 (e.g., new “lead” entity), to update an existing entity (e.g., update the “lead” entity), or the like.

In some exemplary embodiments, User Device 930 may execute, simultaneously, Target System 900 and Assistance Layer 910. In some exemplary embodiments, Assistance Layer 910, defined by a DAP, may function as an intermediate layer between User Device 930 and Target System 900. As one example, Target System 900 may be a web-based system. In such cases, User Device 930 may utilize a web browser to enable interactions with Target System 900. In such cases, client-side code in the code of the Target System 900 may invoke Assistance Layer 910 directly to implement its functionality when the user access Target System 900 using the browser. Additionally, or alternatively, a browser extension may be installed, and such extension may inject the client-side code of Assistance Layer 910 to the fetched web pages, thereby invoking Assistance Layer 910 to implements its functionality. In other cases, Assistance Layer 910 may be executed in any other manner. In some exemplary embodiments, Assistance Layer 910 may be separate from Target System 900, may not collaborate therewith, may not perform Application Programming Interface (API) calls to Target System 900, may not have access to a backend of Target System 900, or the like.

In some exemplary embodiments, Assistance Layer 910 may utilize one or more validation tooltips with Field Validators 912 in order to validate user inputs to respective Fields 904. In some cases, some fields in Page 902 may not have any corresponding tooltips with Field Validators 912. Additionally, or alternatively, some fields may have several corresponding Field Validators 912, such as associated with a different segment of end users. In such cases, Assistance Layer 910 may be configured to select the relevant Field Validator 912 for each end user.

In some exemplary embodiments, Field Validators 912 may utilize one or more LLM engines, such as LLM Engine 920, to evaluate whether user inputs to Fields 904 comply with LLM rules. In some cases, LLM Engine 920 may be on-premise, on a private tenant in the cloud, on a public cloud, or the like. Specific deployment may vary depending on confidentiality and privacy concerns associated with data that is transmitted to LLM Engine 920. Additionally, or alternatively, several different LLM Engines 920 may be deployed at different locations, enabling usage of different engines for different content, tasks, or the like.

In some exemplary embodiments, an end user using User Device 930 may enter input to a field of Fields 904 (e.g., a trigger event), causing a respective validator of Field Validators 912 to be executed. In some exemplary embodiments, a prompt may be generated, using the input from User Device 930 and an LLM rule defined by an admin user (the admin user that defined the Assistance Layer 910 via the DAP, who is not associated with Target System 900), and provided to LLM Engine 920. LLM Engine 920 may determine whether the input complies with the LLM rule. In case of violation of the LLM rule, LLM Engine 920 may provide content-based feedback, such as providing suggestions indicating how the input can be enhanced to comply with the LLM rule.

In some exemplary embodiments, the validation tooltip may obtain the result from LLM Engine 920, and present an output on the screen of User Device 930 based on the result.

In some cases, a Chat GUI Layer 914 may be used to communicate with the user of User Device 930, e.g., according to the method of FIG. 8. For example, the assistance layer may deploy Chat GUI Layer 914 over the GUI of Target System 900, e.g., as an overlay. In some cases, the end user may interact with the Chat GUI Layer 914 to provide thereto inputs to one or more of Fields 904, and Chat GUI Layer 914 may generate prompts accordingly and provide feedback to the inputs within the chat. As an example, Chat GUI Layer 914 may comprise a chat-bot that is used to communicate with the end user in natural language, using textual input modality, using vocal commands, or the like, using LLM Engine 920 to generate natural language messages.

In some exemplary embodiments, when the end user interacts with Chat GUI Layer 914, Chat GUI Layer 914 may utilize LLM engine 920 to implement the conversation with the user in natural language. In some exemplary embodiments, LLM Engine 920 may be utilized to validate the user input according to one or more LLM rules of respective Fields 904, Field Validator 912 of Fields 904, or the like, in order to provide content-based feedback to non-compliant input, or the like. For example, Chat GUI Layer 914 may present one or more questions to the end user, prompting the end user to provide relevant information to all Fields 904 of Page 902. In some cases, the questions may focus only on Fields 904 that are mandatory in Page 902, on Fields 904 that have LLM rules, on all on Fields 904, or the like.

In some exemplary embodiments, once Chat GUI Layer 914 determines that the one or more respective inputs to Fields 904 are compliant with Field Validator 912, Chat GUI Layer 914 may provide the inputs to Field Validator 912. In some cases, Chat GUI Layer 914 may process the inputs prior to providing them to Field Validator 912, such as by summarizing the conversation. For example, Field Validators 912 may provide the inputs, in their original or processed version, to the automation process of the fields, which may enter the inputs to Fields 904 automatically, by simulating a user interaction with a GUI. In other cases, Chat GUI Layer 914 may invoke a separate automation process to enter the inputs to Fields 904 automatically. In some exemplary embodiments, once the validated inputs are provided to Fields 904, a form of Page 902 may be submitted to Target System 900.

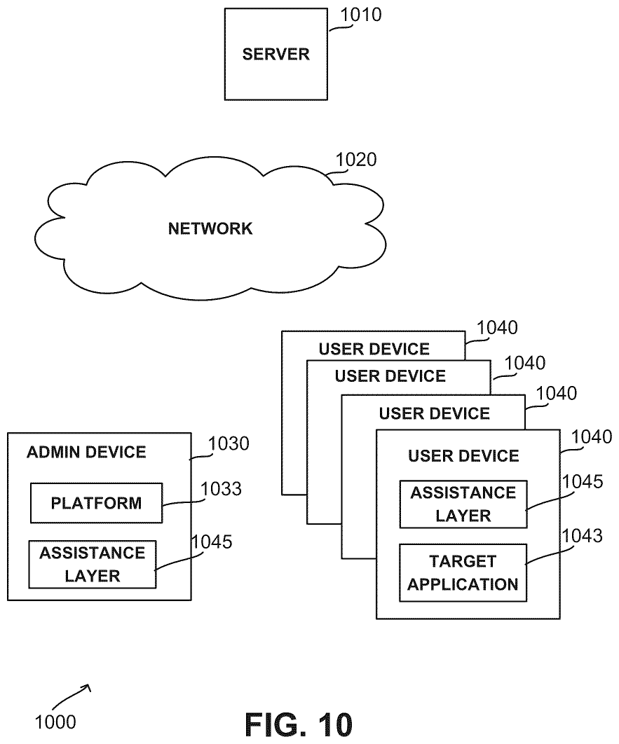

Referring now to FIG. 10 showing a schematic illustration of an exemplary environment in which the disclosed subject matter may be utilized, in accordance with some exemplary embodiments of the disclosed subject matter.

In some exemplary embodiments, Environment 1000 may comprise a plurality of User Devices 1040. User Devices 1040 may comprise Personal Computers (PCs), stationary computers, tablets, smartphones, or the like, of respective end users. User Devices 1040 may be connected to a Computerized Network 1020, such as a Wide Area Network (WAN), a Local Area Network (LAN), a wireless network, the Internet, an intranet, or the like.

In some exemplary embodiments, User Devices 640 may deploy and execute a third-party application, program, or the like, e.g., Target Application 1043. For example, Target Application 1043 may comprise a SALESFORCE™ application, Zendesk™, or the like. In some exemplary embodiments, Target Application 1043 may comprise web page, a web application, a browser extension, a mobile application, a desktop application, or the like. In some exemplary embodiments, Target Application 1043 may display to an end-user one or more screens, constituting a GUI, which may comprise one or more GUI elements.

In some exemplary embodiments, Environment 1000 may comprise an Administrator Computer 1030 (denoted “admin device”), operated by an administrator user or another user with suitable credentials and permissions. In some exemplary embodiments, Administrator Computer 1030 may be connected to Computerized Network 1020.

In some exemplary embodiments, Administrator Computer 1030 may deploy, execute, or the like, Platform 1033 and Target Application 1043 (not depicted). For example, Platform 1033 may comprise a software platform, such as a DAP platform, that is configured to enable users to generate an assistance layer, e.g., Assistance Layer 1045 over Target Application 1043. For example, Assistance Layer 1045 may be generated to comprise validation tooltips or any other validation widgets for third-party applications such as Target Application 1043. In some exemplary embodiments, the admin user may define, via Platform 1033 of Administrator Computer 1030, one or more validation tooltips to be applied on respective fields of a form displayed by Target Application 1043.

In some exemplary embodiments, the validation tooltips may be defined to have a plurality of settings, configurations, or the like, such as trigger events (indicating data was entered to a field) that cause automation processes to be executed, automation processes that perform validation of user input, presentation configurations for presenting validation outputs, or the like.

In some exemplary embodiments, defined validation tooltips in Assistance Layer 1045, may be made available to User Devices 1040. For example, Assistance Layer 1045 may be generated as a program product executable by a computer, such as, without limitations, a script, a software, a browser extension, a mobile application, a web application, a Software Development Kit (SDK), a shared library, a Dynamic Link Library (DLL), a SaaS, or the like. According to this example, Assistance Layer 1045 may be defined by the admin user and provided to User Devices 1040 by sending the program product to User Devices 1040. As another example, Assistance Layer 1045 may be made available to User Devices 1040 via API calls to a cloud or server storing the defined widgets, e.g., Server 1010. As another example, Assistance Layer 1045 may be made available to User Devices 1040 via updates to an existing application or software agent deployed by User Devices 1040.

In some exemplary embodiments, at least one User Device 1040 may execute corresponding Assistance Layer 1045, Target Application 1043, or the like, e.g., simultaneously. In some exemplary embodiments, Assistance Layer 1045 may be executed over Target Application 1043, and may enable users of User Device 1040 to obtain content-based feedback on their inputs to fields of Target Application 1043, to obtain indications of whether or not their inputs are validated, or the like.

In some cases, User Devices 1040 may execute a software agent (not depicted) associated with Assistance Layer 1045. For example, the software agent may be configured to acquire GUI elements appearing in GUIs of Target Application 1043, communicate the acquired data to a server such as Server 1010, and apply Assistance Layer 1045 over the GUI according to data from Server 1010. In some cases, the software agent may correspond to one or more software agents disclosed in U.S. Pat. No. 10,620,975, entitled “GUI Element Acquisition Using A Plurality Of Alternative Representations Of The GUI Element”, dated Apr. 14, 2020, which is incorporated by reference in its entirety for all purposes without giving rise to disavowment. As another example, Assistance Layer 1045 may be executed independently, without relying on Server 1010.

For example, a trigger event may be identified by an agent executed over User Device 1040, e.g., by monitoring the screen of User Device 1040 and determining that the user inserted data to a field of Target Application 1043 for which Assistance Layer 1045 has a defined validation tooltip. Upon identifying the data from the user, a respective automation process may be executed, such as a validation process encompassing exploitation of LLM technology to validate the data. A result or output from the validation process may be presented to a user of User Device 1040 according to configurations of the Assistance Layer 1045, its tooltip, or the like, thereby assisting the user with performing a digital task of filling out the field.

In some exemplary embodiments, Server 1010 may be connected to Computerized Network 1020. Server 1010 may be connected directly, indirectly, or the like, to Administrator Computer 1030, to User Devices 1040, or the like, such as via Computerized Network 1020. In some exemplary embodiments, Server 1010 and Administrator Computer 1030 may or may not be implemented by the same physical device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method to be implemented at an end device of an administrator user, the method comprising:
selecting a page element in a page of a third-party application, the page element comprising a field, wherein the third-party application is executable on the end device of the administrator user and on a plurality of end devices of end users;
defining a trigger event, wherein the trigger event comprises identifying that an end user entered input to the field;
defining an automation process to be executed in response to an occurrence of the trigger event, the automation process is configured to generate a prompt to a Generative Artificial Intelligence (AI) engine to incorporate at least the input and a validation rule, wherein said defining the automation process comprises defining the validation rule using free text in natural language, wherein the prompt is configured to be generated to comprise a predefined structure of a static portion and a dynamic portion, wherein the dynamic portion is configured to be populated with inputs from the end users in response to respective invocations of trigger events, wherein the static portion is configured to comprise the validation rule and instructions to determine whether the input complies with the validation rule, the automation process is configured to send the prompt to the Generative AI engine and obtain an output from the Generative AI engine in response to the prompt; and
defining a configuration for presenting a result over the page, wherein the result is determined based on the output from the Generative AI engine, the result indicating at least whether the input complies with the validation rule.

2. The method of claim 1, wherein the prompt is configured to instruct the Generative AI engine to provide content-based feedback on the input, the content-based feedback comprising a suggestion of how to adjust the input in a manner that will comply with the validation rule.

3. The method of claim 1, wherein the configuration of presenting the result comprises at least one of:
updating one or more properties of the page based on the result, the one or more properties comprise at least one of: a border color of the field, a background color of the field, or a highlight of the field; and
presenting the result as an overlay over the page, the overlay is configured to be displayed over the page, wherein the overlay is not part of the third-party application, the overlay comprising at least one of: a chat widget, a tooltip, a popup element, or a text field.

4. The method of claim 1, wherein the dynamic portion is configured to be populated, every invocation of the trigger event, with contextual data, the contextual data comprising data from the page.

5. The method of claim 4, wherein the data from the page comprises names of other fields in the page and at least some inputs to the other fields.

6. The method of claim 4, wherein the data from the page comprises validation rules of other fields in the page.

7. The method of claim 6, wherein the other fields comprise fields of a form, wherein the validation rules of the other fields are defined to validate inputs of the end users into the fields of the form.

8. The method of claim 1, wherein said selecting the page element, defining the trigger event, defining the automation process, and defining the configuration are performed via a digital adoption platform that is executing on the end device of the administrator user, the digital adoption platform is agnostic to the third-party application, wherein the digital adoption platform is configured to enable administrator users to generate, using the digital adoption platform, an assistance layer to be executed over the third-party application on the plurality of end devices, the assistance layer is configured to assist the end users with performing digital tasks.

9. The method of claim 8, wherein the instructions of the prompt comprise pre-configured instructions of the digital adoption platform that are not defined by the administrator user.

10. The method of claim 8, wherein the digital tasks comprise filling out one or more forms in the third-party application.

11. The method of claim 8, wherein the assistance layer comprises a validation tooltip defined for the field, the validation tooltip is configured to comprise the validation rule.

12. The method of claim 11 further comprising:
defining to present to the end user a guidance message prior to the input being entered to the field; and
selecting the guidance message from a set of one or more pre-defined messages of the validation tooltip, the set of one or more pre-defined messages are historical messages for the field defined by one or more users of an organization to which the administrator user belongs.

13. The method of claim 1, wherein the configuration of presenting the result comprises presenting the result as a message within a chat widget, the chat widget is overlayed over the page, wherein the input to the field is provided to the chat widget, wherein the automation process is configured to provide a summary of compliant inputs in the chat widget to the field.

14. The method of claim 1, wherein the Generative AI engine comprises a Large Language Model (LLM) engine or a Small Language Model (SLM) engine.

15. A method to be implemented at an end device of an end user, the method comprising:
displaying on the end user a third-party application and an assistance layer, the assistance layer is executed over the third-party application;
obtaining, from the end user, user input to a field in a page of the third-party application;
presenting to the end user a message over the page, the message is obtained from the assistance layer, the message indicating that content of the user input does not comply with a validation rule of the assistance layer, the message provides content-based feedback to the user input, the content-based feedback comprising a suggestion of how to adjust the content of the user input in a manner that will comply with the validation rule, wherein the assistance layer is configured to generate a prompt to a Generative Artificial Intelligence (AI) engine, send the prompt to the Generative AI engine, and obtain the content-based feedback from the Generative AI engine, the prompt comprising a predefined structure of a static portion and a dynamic portion, wherein the dynamic portion is configured to be populated with the user input every time the field is filled out by the end user, wherein the static portion is configured to comprise the validation rule; and
obtaining modified user input to the field, the modified user input is obtained subsequently to said presenting the message.

16. The method of claim 15, wherein before said obtaining the user input, a guidance message is presented to the end user, the guidance message comprises pre-defined text guiding the end user how to fill out the field, the pre-defined text provided by a builder of the assistance layer.

17. The method of claim 15, wherein the Generative AI engine comprises a Large Language Model (LLM) engine or a Small Language Model (SLM) engine.

18. A computer program product comprising a non-transitory computer readable medium retaining program instruction, which program instructions when read by a processor, cause the processor to perform, at an end device of an end user, a method comprising:
displaying on the end user a third-party application and an assistance layer, the assistance layer is executed over the third-party application;
obtaining, from the end user, user input to a field in a page of the third-party application;
presenting to the end user a message over the page, the message is obtained from the assistance layer, the message indicating that content of the user input does not comply with a validation rule of the assistance layer, the message provides content-based feedback to the user input, the content-based feedback comprising a suggestion of how to adjust the content of the user input in a manner that will comply with the validation rule, wherein the assistance layer is configured to generate a prompt to a Generative Artificial Intelligence (AI) engine, send the prompt to the Generative AI engine, and obtain the content-based feedback from the Generative AI engine, the prompt comprising a predefined structure of a static portion and a dynamic portion, wherein the dynamic portion is configured to be populated with the user input every time the field is filled out by the end user, wherein the static portion is configured to comprise the validation rule; and
obtaining modified user input to the field, the modified user input is obtained subsequently to said presenting the message.

19. The computer program product of claim 18, wherein the dynamic portion is populated with contextual data from the page, the contextual data comprising at least one of: names of other fields in the page, validation rules of the other fields, or inputs from the end user to the other fields.

20. The computer program product of claim 18, wherein the assistance layer comprises a validation tooltip defined for the field, the validation tooltip comprises the validation rule.

21. The computer program product of claim 18, wherein the message is presented within a chat widget of the assistance layer, the chat widget is overlayed over the page, wherein the user input to the field is provided via the chat widget.

22. An apparatus comprising a processor and coupled memory, said processor being adapted to perform, at an end device of an administrator user, the steps of:
selecting a page element in a page of a third-party application, the page element comprising a field, wherein the third-party application is executable on the end device of the administrator user and on a plurality of end devices of end users;
defining a trigger event, wherein the trigger event comprises identifying that an end user entered input to the field;
defining an automation process to be executed in response to an occurrence of the trigger event, the automation process is configured to generate a prompt to a Generative Artificial Intelligence (AI) engine to incorporate at least the input and a validation rule, wherein said defining the automation process comprises defining the validation rule using free text in natural language, wherein the prompt is configured to be generated to comprise a predefined structure of a static portion and a dynamic portion, wherein the dynamic portion is configured to be populated with inputs from the end users in response to respective invocations of trigger events, wherein the static portion is configured to comprise the validation rule and instructions to determine whether the input complies with the validation rule, the automation process is configured to send the prompt to the Generative AI engine and obtain an output from the Generative AI engine in response to the prompt; and
defining a configuration for presenting a result over the page, wherein the result is determined based on the output from the Generative AI engine, the result indicating at least whether the input complies with the validation rule.
